(19) United States
(12) Patent Application Publication
(10) Pub. No.: US 2025/0348802 A1
(43) Pub. Date: Nov. 13, 2025

(54) APPARATUS, METHOD, AND COMPUTER PROGRAM PRODUCT FOR OUTPUTTING A RESOURCE CONTAINER UNIT AGGREGATION INSIGHT INTERFACE COMPONENT TO A RESOURCE OPERATIONAL INTERFACE

(71) Applicant: ATLASSIAN US, INC., San Francisco, CA (US)

(72) Inventors: Alexander Quoc Dang DUONG, Boise, ID (US); Willy Henri DU PREEZ, Santa Clara, CA (US); Chase Bradley NIELSON, Lehi, UT (US); Sofia Alejandra RUIZ URZUA, Laguna Beach, CA (US); Natalie Kate JOHNSON, San Francisco, CA (US); Kelly Caroline SNOW, San Francisco, CA (US); Traci Ann WILBANKS, Oakland, CA (US); Samantha UGULAVA, Palo Alto, CA (US)

(21) Appl. No.: 18/657,193

(22) Filed: May 7, 2024

(51) Int. Cl. G06Q 10/0631

(52) U.S. Cl. CPC G06Q 10/06311

(57) ABSTRACT

Apparatus, methods, and computer program products for outputting a resource container unit aggregation insight map interface to a resource operational interface are provided. A method may include detecting a resource container unit aggregation insight map interface request, accessing a plurality of candidate resource container units, determining a selected resource container unit set from the plurality of candidate resource container units, generating a resource container unit aggregation insight map interface comprising a plurality of resource container unit interface components corresponding to the selected resource container unit set, the resource container unit aggregation insight map interface configured to visually depict at least two of the resource container unit interface components in a hierarchical mapping arrangement, and outputting the resource container unit aggregation insight map interface for rendering to the resource operational interface.

### BACKGROUND

Various methods, apparatuses, and systems provide tools allowing users to plan, coordinate, collaborate, track, monitor, execute, address, resolve, and/or otherwise manage multiple resources, projects, and work in resource operation management and collaboration systems. Applicant has identified a number of deficiencies and problems associated with effectively and reliably surfacing metrics and other relevant data for managing, monitoring, and understanding status and progress associated with such resources, projects, and work in existing resource operation management and collaboration systems, especially with respect to higher-level goals, plans, objectives, milestones, and initiatives when scaling to the enterprise level of an organization, as such resources, projects, and work are based on a variety of underlying disparate assumptions, considerations, and data sets. Through applied effort, ingenuity, and innovation, many of these identified deficiencies and problems have been solved by developing solutions that are structured in accordance with the embodiments of the present disclosure, many examples of which are described in detail herein.

### BRIEF SUMMARY

In general, embodiments of the present disclosure provided herein include improved methods, apparatuses, systems, and computer program products configured for outputting a resource container unit aggregation insight interface component to a resource operational interface, for example, in a resource operation management and collaboration system. In accordance with one exemplary embodiment of the present disclosure, an apparatus for outputting a resource container unit aggregation insight map interface to a resource operational interface is provided. The apparatus may include at least one processor, and at least one memory including program code, the at least one memory and the program code configured to, with the at least one processor, cause the apparatus to at least detect a resource container unit aggregation insight map interface request in response to user interaction with a resource operational interface; access a plurality of candidate resource container units; determine a selected resource container unit set from the plurality of candidate resource container units based on the resource container unit aggregation insight map interface request; generate a resource container unit aggregation insight map interface comprising a plurality of resource container unit interface components corresponding to the selected resource container unit set, the resource container unit aggregation insight map interface configured to visually depict at least two of the resource container unit interface components in a hierarchical mapping arrangement; and output the resource container unit aggregation insight map interface for rendering to the resource operational interface.

In some embodiments, visually depicting at least two of the resource container unit interface components in a hierarchical mapping arrangement includes identifying a first resource container unit interface component of the at least two resource container unit interface components as a parent resource container unit; identifying a second resource container unit interface component of the at least two resource container unit interface components as a child resource container unit to the first resource container unit interface component; and causing display of a visual linkage element between the first and second resource container unit interface components to visually depict the hierarchical mapping arrangement as a parent-child hierarchical mapping arrangement.

In some embodiments, each of the resource container unit interface components comprises one or more of resource container unit title data, resource container unit progress data, resource container unit owner data, resource sub-container unit data, resource container unit key result data, resource container unit target completion data, resource container unit status data, resource container unit qualitative update data, resource container unit risk data, resource container unit financial data, or resource container unit team data. In certain embodiments, a first resource container unit interface component comprises a visual emphasis element based on the resource container unit progress data, wherein the visual emphasis element is configured to visually compare current resource container unit progress data to target resource container unit data. In still further embodiments, a first resource container unit interface component comprises a visual emphasis element based on the resource container unit risk data, wherein the visual emphasis element is configured to visually depict a current resource container unit risk.

In some embodiments, the program code is further configured to, with the at least one processor, cause the apparatus to detect a detailed resource container unit insight interface component request in response to user interaction with a first resource container unit interface component of the resource container unit aggregation insight map interface; generate a detailed resource container unit insight interface component comprising one or more additional resource container unit data; and cause replacement of the first selected resource container unit with the detailed resource container unit insight interface component in the resource container unit aggregation insight map interface.

In some embodiments, the program code is further configured to, with the at least one processor, cause the apparatus to detect an emphasize resource container unit interface component request in response to user interaction with a first resource container unit interface component of the resource container unit aggregation insight map interface; generate a visual emphasis element configured to visually emphasize the first resource container unit interface component in comparison to at least one other resource container unit interface component of the plurality of resource container unit interface components; and output the visual emphasis element to the resource container unit aggregation insight map interface for rendering in association with the first resource container unit interface component.

In some embodiments, the program code is further configured to, with the at least one processor, cause the apparatus to detect an insert resource container unit interface component request in response to user interaction with the resource container unit aggregation insight map interface; and output a new resource container unit interface component to the resource container unit aggregation insight map interface.

In some embodiments, the program code is further configured to, with the at least one processor, cause the apparatus to detect a reassign resource container unit interface component request in response to user interaction with at least one resource container unit interface component of the resource container unit aggregation insight map interface; generate an updated resource container unit aggregation insight map interface comprising the plurality of resource container unit interface components, the updated resource container unit aggregation insight map interface configured to visually depict the at least one resource container unit interface component in a revised hierarchical mapping arrangement; and output the updated resource container unit aggregation insight map interface for rendering to the resource operational interface. In certain embodiments, the reassign resource container unit interface component request comprises a user identifier, previous parent resource container unit data, and new parent resource container unit data, and wherein the program code is further configured to, with the at least one processor, cause the apparatus to store the user identifier, the previous parent resource container unit data, the new parent resource container unit data, and a timestamp in association with the at least one resource container unit interface component.

In accordance with another exemplary embodiment of the present disclosure, a method for outputting a resource container unit aggregation insight map interface to a resource operational interface is provided, the method comprising detecting a resource container unit aggregation insight map interface request in response to user interaction with a resource operational interface; accessing a plurality of candidate resource container units; determining a selected resource container unit set from the plurality of candidate resource container units based on the resource container unit aggregation insight map interface request; generating a resource container unit aggregation insight map interface comprising a plurality of resource container unit interface components corresponding to the selected resource container unit set, the resource container unit aggregation insight map interface configured to visually depict at least two of the resource container unit interface components in a hierarchical mapping arrangement; and outputting the resource container unit aggregation insight map interface for rendering to the resource operational interface.

In some embodiments, visually depicting at least two of the resource container unit interface components in a hierarchical mapping arrangement comprises identifying a first resource container unit interface component of the at least two resource container unit interface components as a parent resource container unit; identifying a second resource container unit interface component of the at least two resource container unit interface components as a child resource container unit to the first resource container unit interface component; and causing display of a visual linkage element between the first and second resource container unit interface components to visually depict the hierarchical mapping arrangement as a parent-child hierarchical mapping arrangement.

In some embodiments, each of the resource container unit interface components comprises one or more of resource container unit title data, resource container unit progress data, resource container unit owner data, resource container unit target completion data, resource sub-container unit data, resource container unit key result data, resource container unit status data, resource container unit qualitative update data, resource container unit risk data, resource container unit financial data, or resource container unit team data.

In some embodiments, the method further comprises detecting a detailed resource container unit insight interface component request in response to user interaction with a first resource container unit interface component of the resource container unit aggregation insight map interface; generating a detailed resource container unit insight interface component comprising one or more additional resource container unit data; and causing replacement of the first selected resource container unit with the detailed resource container unit insight interface component in the resource container unit aggregation insight map interface.

In some embodiments, the method further comprises detecting an emphasize resource container unit interface component request in response to user interaction with a first resource container unit interface component of the resource container unit aggregation insight map interface; generating a visual emphasis element configured to visually emphasize the first resource container unit interface component in comparison to at least one other resource container unit interface component of the plurality of resource container unit interface components; and outputting the visual emphasis element to the resource container unit aggregation insight map interface for rendering in association with the first resource container unit interface component.

In some embodiments, the method further comprises detecting an insert resource container unit interface component request in response to user interaction with the resource container unit aggregation insight map interface; and outputting a new resource container unit interface component to the resource container unit aggregation insight map interface.

In some embodiments, the method further comprises detecting a reassign resource container unit interface component request in response to user interaction with at least one resource container unit interface component of the resource container unit aggregation insight map interface; generating an updated resource container unit aggregation insight map interface comprising the plurality of resource container unit interface components, the updated resource container unit aggregation insight map interface configured to visually depict the at least one resource container unit interface component in a revised hierarchical mapping arrangement; and outputting the updated resource container unit aggregation insight map interface for rendering to the resource operational interface. In certain embodiments, the reassign resource container unit interface component request comprises a user identifier, previous parent resource container unit data, and new parent resource container unit data, and the method further comprises storing the user identifier, the previous parent resource container unit data, the new parent resource container unit data, and a timestamp in association with the at least one resource container unit interface component.

In accordance with another exemplary embodiment of the present disclosure, a computer program product for outputting a resource container unit aggregation insight map interface to a resource operational interface is provided, the computer program product comprising at least one non-transitory computer-readable storage medium having computer-readable program code portions stored therein, the computer-readable program code portions comprising an executable portion configured to detect a resource container unit aggregation insight map interface request in response to user interaction with a resource operational interface; access a plurality of candidate resource container units; determine a selected resource container unit set from the plurality of candidate resource container units based on the resource container unit aggregation insight map interface request; generate a resource container unit aggregation insight map interface comprising a plurality of resource container unit interface components corresponding to the selected resource container unit set, the resource container unit aggregation insight map interface configured to visually depict at least two of the resource container unit interface components in a hierarchical mapping arrangement; and output the resource container unit aggregation insight map interface for rendering to the resource operational interface. In certain embodiments, the computer-readable program code portions comprising an executable portion are further configured to output a visual emphasis element in association with at least one resource container unit interface component, the visual emphasis element configured to visually compare current resource container unit progress data to target resource container unit data of the at least one resource container unit interface component.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject matter will become apparent from the description, the drawings, and the claims.

### BRIEF DESCRIPTION OF THE SEVERAL VIEWS OF THE DRAWINGS

Having thus described certain example embodiments of the present disclosure in general terms above, non-limiting and non-exhaustive embodiments of the subject disclosure will now be described with reference to the accompanying drawings which are not necessarily drawn to scale. The components illustrated in the accompanying drawings may or may not be present in certain embodiments described herein. Some embodiments may include fewer (or more) components than those shown in the drawings:

FIG. 1 illustrates an example resource operation management and collaboration system configured to communicate with various client devices in accordance with various example embodiments described herein.

FIG. 2 is a schematic block diagram of example circuitry for a resource operation management server to perform various operations in accordance with various embodiments of the subject disclosure.

FIGS. 3A and 3B illustrate example resource container unit aggregation insight map interfaces structured in accordance with various embodiments of the subject disclosure.

FIG. 4A illustrates an example resource container unit interface component structured in accordance with example embodiments of the subject disclosure.

FIG. 4B illustrates an example detailed resource container unit interface component structured in accordance with example embodiments of the subject disclosure.

FIG. 5A illustrates another example resource container unit interface component structured in accordance with example embodiments of the subject disclosure.

FIG. 5B illustrates another example detailed resource container unit interface component structured in accordance with example embodiments of the subject disclosure.

FIG. 6 is a flowchart illustrating example operations for outputting a resource container unit aggregation insight interface for rendering to a resource operational interface in accordance with some example embodiments of the present disclosure.

FIG. 7 is a flowchart illustrating example operations for outputting a visual emphasis element to a resource container unit aggregation insight map interface in accordance with some example embodiments of the present disclosure.

FIG. 8 is a flowchart illustrating example operations for outputting a new resource container unit interface component to a resource container unit aggregation insight map interface in accordance with some example embodiments of the present disclosure.

FIG. 9 is a flowchart illustrating example operations for outputting an updated resource container unit aggregation insight map interface for rendering to a resource operational interface in accordance with some example embodiments of the present disclosure.

FIG. 10 is a flowchart illustrating example operations for visually depicting resource container unit interface components in a hierarchical mapping arrangement in accordance with example embodiments of the subject disclosure.

### DETAILED DESCRIPTION

One or more embodiments now will be more fully described with reference to the accompanying drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details (and without applying to any particular networked environment or standard). It should be understood that some, but not all embodiments are shown and described herein. Indeed, the embodiments may be embodied in many different forms, and accordingly this disclosure should not be construed as limited to the embodiments set forth herein. Rather, these embodiments are provided so that this disclosure will satisfy applicable legal requirements. As used herein, the description may refer to a server or client device as an example “apparatus.” However, elements of the apparatus described herein may be equally applicable to the claimed system, method, and computer program product. Accordingly, use of any such terms should not be taken to limit the spirit and scope of embodiments of the present disclosure.

### Overview

Methods, apparatuses, systems, and computer program products are provided in accordance with example embodiments of the present disclosure in order to address technical problems associated with generating and outputting a resource container unit aggregation insight interface component to a resource operational interface, for example, in a resource operation management and collaboration system. A resource operation management and collaboration system enables users to plan, track, organize, schedule, monitor, and/or otherwise manage resources, work items, development projects, and the like. Such a resource operation management and collaboration system may require the management and oversight of, for example, a plurality of agile and non-agile systems. For example, software development projects may be based in an agile project management framework, while HR information and financial planning associated with such software development may be based in non-agile frameworks or otherwise cannot be efficiently interconnected with such agile project management frameworks. In addition, such resources, processes, work, and information may typically be housed in different tools altogether and/or owned by different departments/teams in an organization.

The inventors have determined it would be desirable and advantageous to be able to effectively and reliably surface metrics and other relevant data for managing, monitoring, and understanding status and progress associated with resources, projects, work, and information developed using or originating from, for example, such agile and non-agile frameworks. Such resources, projects, and work, however, are based on a variety of underlying disparate assumptions, considerations, and data sets. For example, an agile software development project may be broken down in a hierarchical manner to smaller actionable work items that can be assigned to self-organizing and cross-functional teams in a series of iterations. Such a de-centralized environment allows for continuous evaluation and improved response to unanticipated changes experienced during the software development project as compared to linear project management, however, the resulting iterative outputs, products, and data resulting from the flexible nature of agile project management are complex as they often are not linear, consistent, or homogenous. Indeed, such data structures produced from an agile project management framework can be dissimilar across teams, scrums, sprints, and projects. Moreover, financial planning associated with such software development is often linear and may span long periods of time, which is inefficient and counter-intuitive to the underlying purpose and adaptability of agile project management. In addition, human resources information, such as team memberships and reporting lines, is not often compatible with such agile project management. Many technical challenges may be encountered in efficiently connecting such financial information and/or HR information with such disparate data from the agile project management frameworks and surfacing relevant information to users. In addition, not only is such information dissimilar, but typically housed in different tools altogether and owned by different departments/teams in the organization. Such difficulties are only exacerbated with respect to higher-level goals, plans, objectives, milestones, and initiatives when scaling to the enterprise level of an organization.

Accordingly, the inventors have determined it would be desirable and advantageous to effectively and reliably surface or expose metrics and other relevant data to a planning user in a contextually relevant way, thereby enabling the planning user to assess the status and progress of higher-level goals, plans, objectives, milestones, and initiatives, in near real-time or real-time, even when the resources, projects, and work are based on or originate from a variety of underlying disparate tools, assumptions, considerations, and data sets. Programmatically analyzing such dissimilar aggregate data in order to dynamically surface or expose such metrics and other relevant data is desirable in order to enable a user to make an informed value determination as well as ensure higher-level goals, plans, objectives, milestones, and initiatives are on-time and continuing to deliver value.

Example embodiments of the present disclosure address the various deficiencies set forth above and otherwise described herein, while also providing various technical benefits. For example, some embodiments of the present disclosure increase the efficiency and effectiveness of a resource operation management and collaboration system itself. These characteristics as well as additional features, functions, and details are described below. Similarly, corresponding and additional embodiments are also described below.

### Definitions

The following explanations of terms are provided to better describe the present disclosure and to guide those of ordinary skill in the art in the practice of the present disclosure.

As used herein, the term “resource operation management and collaboration system” refers to the software platform(s) and associated hardware that is configured to support and maintain a plurality of portfolios, programs, projects, workflows, tools, and all associated functionality. For example, a non-limiting example of a resource operation management and collaboration system may comprise one or more software products such as Jira® or Jira Align® by Atlassian®. Example resource operation management and collaboration systems comprise supporting server(s), repositor(ies), and client devices, and in some embodiments, are further configured to engage with internal resources, external resources, internal applications, and/or external applications.

As used herein, the term “resource operation management server” refers to a software platform and associated hardware that is configured to, inter alia, analyze and aggregate disparate data sets from the resource operation management and collaboration system, identify one or more express linkages in such data sets, determine and generate one or more inferred linkages in such data sets, and generate and/or manage the various interfaces and/or interface components and associated functionality of the resource operation management and collaboration system. For example, in some embodiments, the resource operation management server is configured to generate, output, update and/or otherwise manage resource operational interface(s), resource container unit aggregation insight map interface(s), resource container unit interface component(s), detailed resource container unit insight interface component(s), visual emphasis element(s), and/or the like.

The resource operation management server is accessible via one or more computing devices, is configured to receive various requests (e.g., resource container unit aggregation insight map interface request(s), detailed resource container unit insight interface component request(s), emphasize resource container unit interface component request(s), insert resource container unit interface component request(s), reassign resource container unit interface component request(s), and/or the like), and access one or more data repositories, such as a resource operation management data repository. The functionality of the resource operation management server may be provided via a single server or collection of servers having a common functionality, or the functionality of the resource operation management server may be segmented among a plurality of servers or collections of servers (e.g., microservices) performing subsets of the described functionality of the resource operation management server.

As used herein, the term “resource operation management data repository” refers to a location, such as a database stored on a memory device, which is accessible by one or more computing devices for retrieval and storage of data associated with the resource operation management and collaboration system. For example, the resource operation management data repository may include data associated with resource container units including resource container unit items such as target resource container unit data, resource container unit title data, resource container unit progress data, resource container unit owner data, resource sub-container unit data, resource container unit key result data, resource container unit target completion data, resource container unit status data, resource container unit qualitative update data, resource container unit risk data, resource container unit financial data, resource container unit team data, hierarchical resource container unit data, timestamp data, and/or the like. Such data associated with resource container units may originate from and/or be aggregated from a variety of disparate tools, sources, and frameworks. For example, some resource container unit items may originate from agile frameworks (e.g., sprint progress data from a software development tool 106A) while other resource container unit items may originate from non-agile frameworks (e.g., financial spend and budget data originating from one or more financial tools 108, makeup of a team, organization structural data, and reporting lines originating from an HR tool 109, and/or the like). Still further, some resource container unit items may be generated from disparate data sources (e.g., resource container unit risk data may be generated from data originating from agile and non-agile frameworks, resource container unit financial data may be generated from aggregated data originating from a financial tool 108, resource container unit team data may be generated from data originating from an HR tool). The resource operation management data repository may be a dedicated device and/or part of a larger repository. The resource operation management data repository may be dynamically updated or may be static. In some embodiments, the resource operation management data repository is encrypted in order to limit unauthorized access of data associated with the resource operation management and collaboration system.

As used herein, the terms “resource operation management application” or “resource operation management app” refer to a dedicated software program, application, platform, service, web browser, or computer-executable application software programmed or configured to run on a client device which provides the user access to the resource management and collaboration system and its associated functionality. In some embodiments, the resource operation management application may include hardware, software, or combinations thereof operating remotely (e.g., on a server). In some embodiments, the resource operation management application is designed to execute on mobile devices, such as tablets or smartphones. For example, in certain embodiments, an app is provided that executes on mobile device operating systems such as iOS®, Android®, or Windows®. These platforms typically provide frameworks that allow apps to communicate with one another and with particular hardware and software components of mobile devices. For example, the mobile operating systems named above each provide frameworks for interacting with location services circuitry, wired and wireless network interfaces, user contacts, and other applications. Communication with hardware and software modules executing outside of the app is typically provided via application programming interfaces (APIs) provided by the mobile device operating system.

As used herein, the term “resource container unit” refers to a data object that is representative of and/or associated with a goal, objective, initiative, project, plan, portfolio and/or the like associated with a resource management and collaboration system. For example, a resource container unit may be a data object that is representative of and/or associated with non-limiting examples such as an enterprise goal of boosting global guest retention by 15% through unique experiences or implementing an international experiences portfolio in a defined time period. As used herein, the term “resource container unit identifier” refers to a data object by which a resource container unit may be uniquely identified in a resource management and collaboration system. For example, a resource container unit identifier may comprise one or more of American Standard Code for Information Interchange (ASCII) text, encryption keys, identification certificates, a pointer, an Internet Protocol (IP) address, a URL, a MAC address, a memory address, or other unique identifier, or combinations thereof.

The term “resource operational interface” refers to a graphical user interface of a resource operation management and collaboration system that is configured to enable users to view and engage with one or more resource operation management and collaboration system workspaces, views, interfaces, and/or interface components. In some embodiments, for example, a resource operational interface is configured to enable user(s) to view and otherwise engage with one or more resource container unit aggregation insight map interface(s), resource container unit interface component(s), detailed resource container unit insight interface component(s), visual emphasis element(s), and/or the like. In some embodiments, a resource operational interface is rendered to a client device based on data and instructions provided by the resource operation management and collaboration system (e.g., resource operation management server). In some embodiments, such data and instructions are facilitated by a dedicated software application running on the client device. In other embodiments, such data and instructions are provided through a web browser running on the client device.

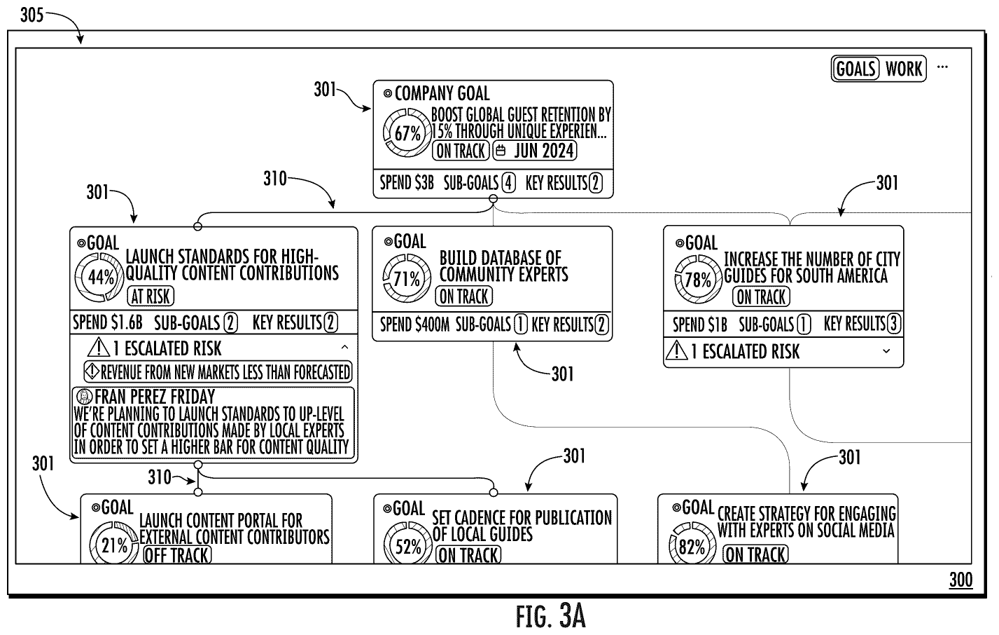

The term “resource container unit aggregation insight map interface” refers to a graphical user interface or graphical user interface element that is rendered to, or as a portion of, a resource operational interface in a resource operation management and collaboration system. In some embodiments, a resource container unit aggregation insight map interface is configured to display one or more “resource container unit interface component(s)”. For example, in some embodiments, a resource container unit aggregation insight map interface may be configured to display one or more resource container unit interface components associated with an enterprise. Indeed, in some embodiments, a resource container unit aggregation insight map interface may be configured to display a plurality of resource container unit interface components. Non-limiting examples of resource container unit aggregation insight map interfaces are depicted in FIGS. 3A and 3B.

In another embodiment, a resource container unit aggregation insight map interface may be configured to visually depict at least two of the resource container unit interface components in a hierarchical mapping arrangement. For example, a first resource container unit interface component may be a parent resource container unit associated with a goal, plan, initiative, or objective and one or more second resource container unit interface component(s) may be child(ren) resource container unit(s), which correlate to sub-goal(s), sub-initiative(s), sub-project(s), work item(s), or the like of the goal, plan, initiative, or objective associated with the parent resource container unit. For example, in some embodiments, a resource container unit aggregation insight map interface may display a visual linkage element (e.g., a line, arrow, etc.) that visually depicts such a parent-child hierarchical mapping arrangement. In some embodiments, a resource container unit aggregation insight map interface may display a plurality of visual linkage elements showing the full or entire relationship (e.g., from upper-most parent to lowest child resource container unit). Such hierarchical mapping arrangement may depict a link, connection, relationship, association, bond, and/or the like between two or more resource container unit interface components.

The term “resource container unit interface component” refers to a graphical user interface element that is rendered to, or as a portion of, a resource container unit aggregation insight map interface. In some embodiments, a resource container unit interface component may be configured to display relevant metrics information based on or more resource container unit items associated with the underlying resource container unit. For example, a resource container unit interface component may be configured to display one or more of resource container unit title data, resource container unit progress data, resource container unit owner data, resource container unit target completion data, resource sub-container unit data, resource container unit key result data, resource container unit status data, resource container unit qualitative update data, resource container unit risk data, resource container unit financial data, and/or resource container unit team data.

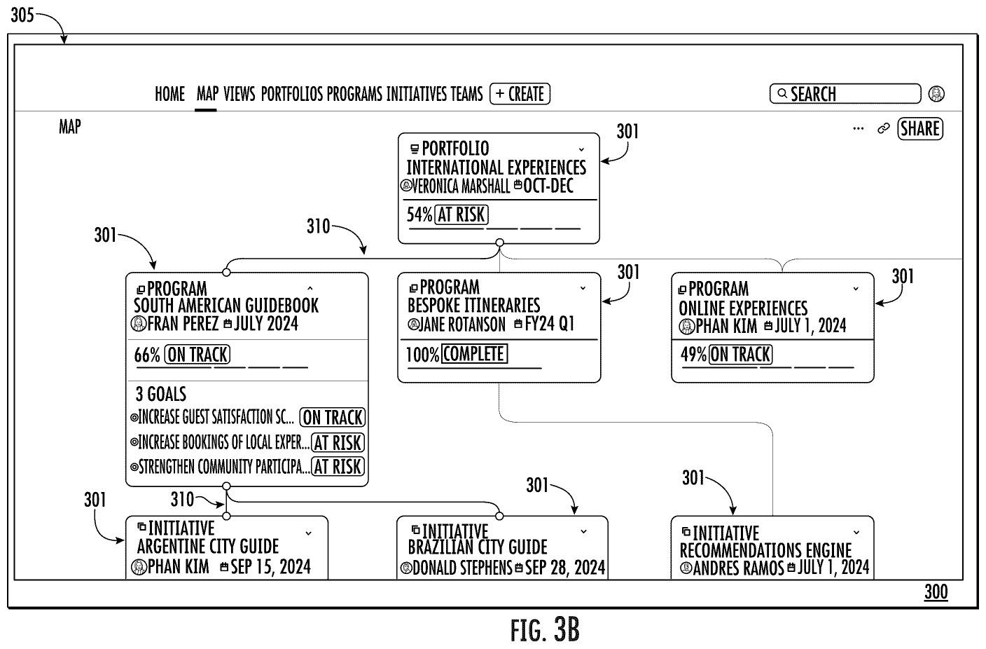

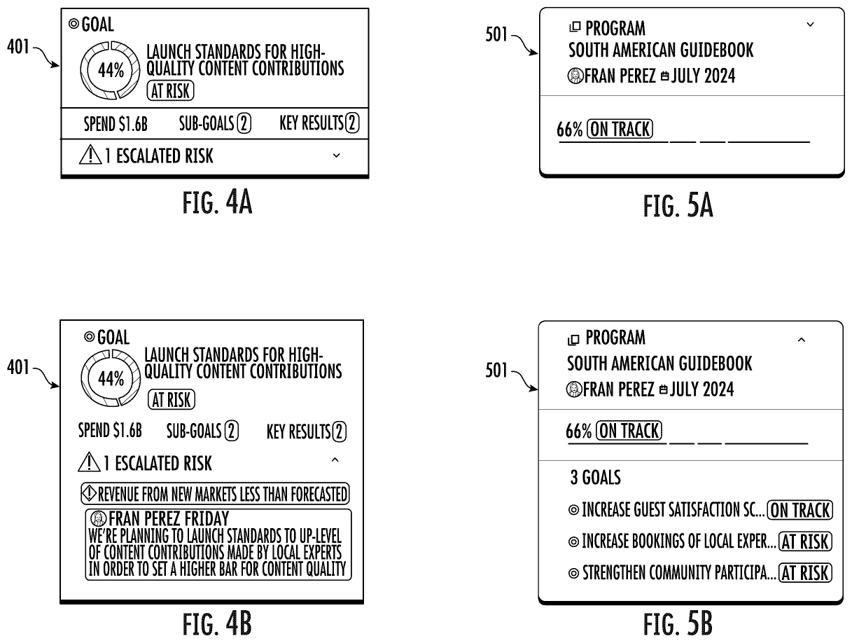

For example, in some embodiments, a resource container unit interface component may be configured to display resource container unit title data of the corresponding resource container unit (e.g., the title of a company goal). As another example, a resource container unit interface component may be configured to display resource container unit owner data of the corresponding resource container unit (e.g., the user responsible for management of a portfolio, program, project, or the like). As another example, a resource container unit interface component may be configured to display resource container unit target completion data of the corresponding resource container unit (e.g., the date by which the underlying goal or initiative is targeted to be completed). As still another example, a resource container unit interface component may be configured to display resource container unit status data of the corresponding resource container unit (e.g., identify the status of the underlying goal or initiative as, for example, “on track”, “off track”, “at risk”, “complete”, etc.). As still another example, a resource container unit interface component may be configured to display resource container unit financial data of the corresponding resource container unit (e.g., associated spend with the underlying company goal). As another example, the resource container unit interface component may comprise a visual emphasis element configured to visually depict the resource container unit progress data in one or more ways. For example, the visual emphasis element may be configured to visually compare, such as alphanumerically and/or via a visual resource container unit progress indicator component (e.g., horizontal status bar(s), vertical status bar(s), pie chart, line chart, radial column chart, donut chart, icons, bubble chart, etc.), the current resource container unit progress data to target resource container unit data, thereby reflecting a progress measurement of the corresponding resource container unit (e.g., goal, initiative, objective, portfolio, program). Such examples are for purposes of illustration and not of limitation and other suitable variations of depicting the resource container unit items are also contemplated by this disclosure as will be apparent to one of ordinary skill in the art. In some embodiments, a resource container unit interface component is configured to display one or more levels of information. For example, FIGS. 4A and 4B and 5A and 5B each illustrate an example embodiment of a resource container unit interface component 400. FIGS. 4A and 5A each depict an example resource container unit interface component exposing a first or summary level of information while FIGS. 4B and 5B each depict an example detailed resource container unit interface component exposing a second or detailed level of information (e.g., in response to a user hovering and/or clicking on a “carrot” or other item displayed in the resource container unit interface component in order to initiate a detailed resource container unit insight interface component request).

The term “visual emphasis element” refers to a visual representation in a graphical user interface configured to visually convey information to the user. For example, in some embodiments, a visual emphasis element is configured to present, emphasize, alter, or otherwise enhance one or more features of an interface component (e.g., a resource container unit interface component) in order to visually convey information (e.g., relevant metrics) associated with the underlying item (e.g., resource container unit) corresponding to the interface component. For example, a visual emphasis element may be configured to visually compare, such as alphanumerically and/or via a visual resource container unit progress indicator component (e.g., horizontal status bar(s), vertical status bar(s), pie chart, line chart, radial column chart, donut chart, icons, bubble chart, etc.), current resource container unit progress data to target resource container unit data, thereby reflecting a progress measurement of the corresponding resource container unit (e.g., goal, initiative, objective, portfolio, program). To provide context, a visual emphasis element may be determined using various embodiments described herein, such as an analysis of current resource container unit progress data and target resource container unit data of a selected resource container unit interface component. Examples of visual representation associated with a visual emphasis element include, but are not limited to, an icon, text, and/or background displayed in a graphical user interface. For example, in a non-limiting illustration, a visual emphasis element for a resource container unit interface component may comprise text in orange, an orange icon (e.g., an arrow or other emphasis), and/or an orange background shading to indicate that the underlying resource container unit associated with the selected resource container unit interface component may be “at risk” due to, for example, lower revenue than forecasted, falling behind projected schedule, and/or other non-limiting examples. In a further example, a visual emphasis element for a resource container unit interface component may comprise text in green, a green icon (e.g., a thumbs up, a checkmark, or other indication of sufficiency), and/or a green background shading to indicate that the underlying resource container unit associated with the selected resource container unit interface component is “on track” due to, for example, expected spend, satisfactory completion of certain sub-goals/sub-initiatives, etc. In a further example, a visual emphasis element for a resource container unit interface component may comprise text in red, a red icon (e.g., a thumbs down, an “X”, or other indication of insufficiency), and/or a red background shading to indicate that the underlying resource container unit associated with the selected resource container unit interface component is “off track” due to, for example, expected spend, severely falling behind schedule, and/or other non-limiting examples. Additional examples of visual emphasis elements include emphasizing an icon or text displayed on a graphical user interface (e.g., coloring scheme, highlighted, bolded, italicized, enlarged, shaded, flashing, pulsing, or changing in size, etc.). Additional examples of visual emphasis elements include numerous embodiments described herein, and would be understood to include any other visual indicators in light of the present disclosure.

As used herein, the term “enterprise” refers to one or more data objects by which a set of users are associated with a particular entity (e.g., employees or contractors of different companies or organizations may be of separate enterprises). As used herein, the term “enterprise identifier” refers to a data object by which an enterprise may be uniquely identified in a resource management and collaboration system. For example, an enterprise identifier data object may comprise one or more of American Standard Code for Information Interchange (ASCII) text, encryption keys, identification certificates, a pointer, an Internet Protocol (IP) address, a URL, a MAC address, a memory address, or other unique identifier, or combinations thereof.

The terms “project identifier” or “project ID” refer to one or more items of data by which a project, such as a stored software development project, may be uniquely identified within a resource operation management and collaboration system. For example, a project identifier may comprise one or more of ASCII text, encryption keys, identification certificates, a pointer, an IP address, a URL, a MAC address, a memory address, or other unique identifier, or combinations thereof.

As used herein, the term “user identifier” refers to one or more items of data by which a user may be uniquely identified within a resource operation management and collaboration system. For example, a user identifier may comprise one or more of American Standard Code for Information Interchange (ASCII) text, encryption keys, identification certificates, a pointer, an Internet Protocol (IP) address, a URL, a MAC address, a memory address, or other unique identifier, or combinations thereof.

The term “resource container unit aggregation insight map interface request” refers to an electrically generated digital object created by a computing device that indicates that a user has provided an input comprising a request to generate and display a resource container unit aggregation insight map interface. In some embodiments, the resource container unit aggregation insight map interface request comprises and/or is associated with a resource container unit identifier. A resource container unit aggregation insight map interface request may be represented via a temporary code that notifies a recipient (e.g., a server) that a user has made the request. To provide further context, a resource container unit aggregation insight map interface request may be generated in response to a user interaction with a computing device wherein a user causes the computing device to generate a resource container unit aggregation insight map interface request. For example, in some embodiments, a user interacts with, for example, a resource operational interface rendered on a visual display of the computing device.

The term “detailed resource container unit insight interface component request” refers to an electrically generated digital object created by a computing device that indicates that a user has provided an input comprising a request to generate and display a detailed resource container unit insight interface component. In some embodiments, the detailed resource container unit insight interface component request comprises and/or is associated with a resource container unit identifier. A detailed resource container unit insight interface component request may be represented via a temporary code that notifies a recipient (e.g., a server) that a user has made the request. To provide further context, a detailed resource container unit insight interface component request may be generated in response to a user interaction (e.g., selection, hovering, etc.) with a computing device wherein a user causes the computing device to generate a detailed resource container unit insight interface component request. For example, in some embodiments, a user interacts with, for example, a resource container unit insight interface component rendered to a resource container unit aggregation insight map interface on a visual display of the computing device.

The term “emphasize resource container unit interface component request” refers to an electrically generated digital object created by a computing device that indicates that a user has provided an input comprising a request to generate and output a visual emphasis element configured to visually emphasize a selected resource container unit interface component in comparison to at least one other resource container unit interface component in a resource container unit aggregation insight map interface. In some embodiments, the emphasize resource container unit interface component request comprises and/or is associated with a resource container unit identifier. An emphasize resource container unit interface component request may be represented via a temporary code that notifies a recipient (e.g., a server) that a user has made the request. To provide further context, an emphasize resource container unit interface component request may be generated in response to a user interaction (e.g., selection, hovering, etc.) with a computing device wherein a user causes the computing device to generate an emphasize resource container unit interface component request. For example, in some embodiments, a user interacts with, for example, a resource container unit insight interface component rendered to a resource container unit aggregation insight map interface on a visual display of the computing device.

The term “insert resource container unit interface component request” refers to an electrically generated digital object created by a computing device that indicates that a user has provided an input comprising a request to generate and output a new resource container unit interface component to a resource container unit aggregation insight map interface. In some embodiments, the insert resource container unit interface component request comprises and/or is associated with a resource container unit identifier. An insert resource container unit interface component request may be represented via a temporary code that notifies a recipient (e.g., a server) that a user has made the request. To provide further context, an insert resource container unit interface component request may be generated in response to a user interaction (e.g., selection, hovering, etc.) with a computing device wherein a user causes the computing device to generate an insert resource container unit interface component request. For example, in some embodiments, a user interacts with, for example, a resource container unit aggregation insight map interface on a visual display of the computing device to indicate a desire to add a new resource container unit interface component to the resource container unit aggregation insight map interface.

The term “reassign resource container unit interface component request” refers to an electrically generated digital object created by a computing device that indicates that a user has provided an input comprising a request to revise the hierarchical mapping arrangement of a resource container unit aggregation insight map interface. In some embodiments, the reassign resource container unit interface component request comprises and/or is associated with one or more of a resource container unit identifier, a user identifier, hierarchical resource container unit data, timestamp data, and/or the like. For example, the reassign resource container unit interface component request may include a resource container unit identifier corresponding to the selected resource container unit interface component to be reassigned, a user identifier corresponding to the user submitting the request, previous parent resource container unit data of the resource container unit interface component, new parent resource container unit data to where the resource container unit interface component is requested to be reassigned, and a timestamp corresponding to the reassign resource container unit interface component request (e.g., for correction of any errors resulting from the reassignment). A reassign resource container unit interface component request may be represented via a temporary code that notifies a recipient (e.g., a server) that a user has made the request. To provide further context, a reassign resource container unit interface component request may be generated in response to a user interaction (e.g., selection, hovering, dragging, dropping, and/or the liked) with a computing device wherein a user causes the computing device to generate a reassign resource container unit interface component request. For example, in some embodiments, a user interacts with, for example, a resource container unit insight interface component rendered to a resource container unit aggregation insight map interface on a visual display of the computing device.

As used herein, the terms “data,” “content,” “digital content,” “digital content object,” “signal,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be transmitted directly to another computing device or may be transmitted indirectly via one or more intermediary computing devices, such as, for example, one or more servers, relays, routers, network access points, base stations, hosts, and/or the like.

The term “computer-readable storage medium” refers to a non-transitory, physical or tangible storage medium (e.g., volatile or non-volatile memory), which may be differentiated from a “computer-readable transmission medium,” which refers to an electromagnetic signal. Such a medium can take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical, infrared waves, or the like. Signals include man-made, or naturally occurring, transient variations in amplitude, frequency, phase, polarization, or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums can be substituted for or used in addition to the computer-readable storage medium in alternative embodiments.

The term “client device,” “computing device,” “network device,” “computer,” “user equipment,” and similar terms may be used interchangeably to refer to computer hardware and/or software that is configured to access a service made available by a server. The server is often (but not always) on another computer system, in which case the client device accesses the service by way of a network. Client devices may include, without limitation, smart phones, tablet computers, laptop computers, wearables, personal computers, enterprise computers, and the like.

As used herein, the term “circuitry” refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of “circuitry” applies to all uses of this term herein, including in any claims. As a further example, the term “circuitry” also includes an implementation comprising one or more processors and/or portion(s) thereof and accompanying software and/or firmware. As another example, the term “circuitry” as used herein also includes, for example, a baseband integrated circuit or applications processor integrated circuit for a mobile phone or a similar integrated circuit in a server, a cellular network device, other network device, and/or other computing device.

As used herein, the terms “application,” “software application,” “app,” “product,” “service” or similar terms refer to a computer program or group of computer programs designed to perform coordinated functions, tasks, or activities for the benefit of a user or group of users. A software application can run on a server or group of servers (e.g., a physical or virtual servers in a cloud-based computing environment). In certain embodiments, an application is designed for use by and interaction with one or more local, networked, or remote computing devices, such as, but not limited to, client devices. Non-limiting examples of an application comprise project management, workflow engines, software incident management, team collaboration suites, cloud services, word processors, spreadsheets, accounting applications, web browsers, email clients, media players, file viewers, video games, audio-video conferencing, and photo/video editors. In some embodiments, an application is a cloud product.

The terms “database,” “repository,” and/or similar terms used herein interchangeable may refer to a collection of records or data that is stored in a computer-readable storage medium using one or more database types. The term “database type” may refer to a type of database, such as a hierarchical database, network database, relational database (e.g., Aurora, RDS), entity-relationship database, object database (e.g., S3), document database, semantic database, graph database, noSqL database (e.g., DynamoDB), and/or the like.

The term “comprising” means including but not limited to and should be interpreted in the manner it is typically used in the patent context. Use of broader terms such as comprises, includes, and having should be understood to provide support for narrower terms such as “consisting of”, “consisting essentially of”, and “comprised substantially of”.

The phrases “in one embodiment,” “according to one embodiment,” “in some embodiments,” and the like generally mean that the particular feature, structure, or characteristic following the phrase may be included in the at least one embodiment of the present disclosure and may be included in more than one embodiment of the present disclosure. Thus, the particular feature, structure, or characteristic may be included in more than one embodiment of the present disclosure such that these phrases do not necessarily refer to the same embodiment.

The terms “illustrative,” “example,” “exemplary” and the like are used herein to mean “serving as an example, instance, or illustration” with no indication of quality level. Any implementation described herein as “exemplary” is not necessarily to be construed as preferred or advantageous over other implementations.

The terms “about,” “approximately,” “generally,” “substantially,” or the like, when used with a number, may mean that specific number, or alternatively, a range in proximity to the specific number, as understood by persons of skill in the art field and may be used to refer to within manufacturing and/or engineering design tolerances for the corresponding materials and/or elements as would be understood by the person of ordinary skill in the art, unless otherwise indicated.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

If the specification presents a list, unless stated otherwise, it is to be understood that each individual element of that list, and every combination of components of that list, is a separate embodiment. For example, “1, 2, 3, 4, and 5” encompasses, among numerous embodiments, 1; 2; 3; 1 and 2; 3 and 5; 1, 3, and 5; and 1, 2, 4, and 5.

The term “set” refers to a collection of one or more items.

The term “plurality” refers to two or more items.

The term “or” is used herein in both the alternative and conjunctive sense, unless otherwise indicated.

### Example System Architecture

Methods, apparatus, and computer program products of the present disclosure may be embodied by any of a variety of computing devices. For example, the method, apparatus, and computer program product of an example embodiment may be embodied by a networked device (e.g., an enterprise platform), such as a server or other network entity, configured to communicate with one or more devices, such as one or more client devices. Additionally, or alternatively, the computing device may include fixed computing devices, such as a personal computer or a computer workstation. Still further, example embodiments may be embodied by any of a variety of mobile devices, such as a portable digital assistant (PDA), mobile telephone, smartphone, laptop computer, tablet computer, wearable, or any combination of the aforementioned devices.

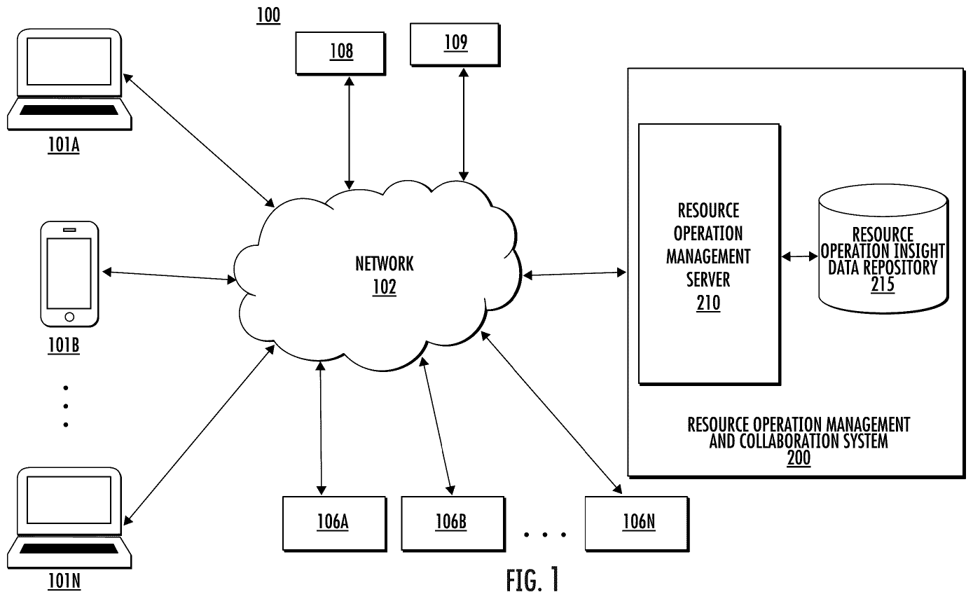

Referring now to FIG. 1, an example computing system 100 architecture within which some embodiments of the present disclosure operate is illustrated. The example computing system 100 comprises a resource operation management and collaboration system 200, a plurality of software development tools 106A-106N, a financial tool 108, an HR tool 109, and a plurality of client devices 101A-101N, each communicatively connected through a communications network 102. Accordingly, user(s) (e.g., high-level users, business leaders (such as CEO, CFO, VP, etc.), project management (PgM) users, team leaders, etc.) may access the resource operation management and collaboration system 200 via the communications network 102 using one or more of client devices 101A-101N. Resource operation management and collaboration system 200 may comprise a resource operation management server 210 in communication with at least one data repository, such as a resource operation insight data repository 215. Such repository(ies) may be hosted by the resource operation management server 210 or otherwise hosted by devices in communication with the resource operation management server 210.

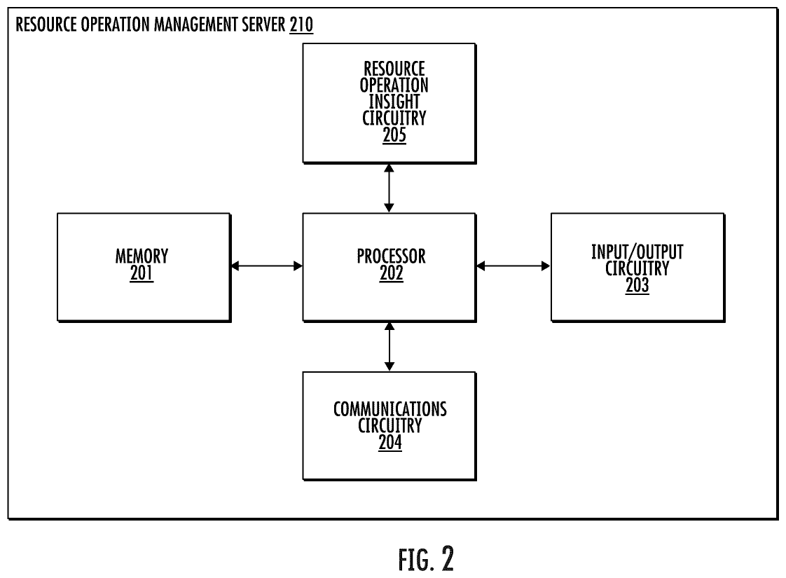

Resource operation management server 210 may include circuitry, networked processors, or the like configured to perform some or all of the resource operation management server-based processes described herein and may be any suitable network server and/or other type of processing device. In some embodiments, resource operation management server 210 may determine and transmit commands and instructions for rendering one or more resource operational interfaces to client devices 101A-101N, using data from, for example, resource operation insight data repository 215. In this regard, the resource operation management server 210 may be embodied by any of a variety of devices, for example, the resource operation management server 210 may be embodied as a computer or a plurality of computers. For example, resource operation management server 210 may be configured to receive/transmit data and may include any of a variety of fixed terminals, such as a server, desktop, or kiosk, or it may comprise any of a variety of mobile terminals, such as a portable digital assistant (PDA), mobile telephone, smartphone, laptop computer, tablet computer, or in some embodiments, a peripheral device that connects to one or more fixed or mobile terminals. Example embodiments contemplated herein may have various form factors and designs but will nevertheless include at least the components illustrated in FIG. 2 and described in connection therewith. In some embodiments, resource operation management server 210 may be located remotely from the resource operation insight data repository 215, although in other embodiments, the resource operation management server 210 may comprise the resource operation insight data repository 215. The resource operation management server 210 may, in some embodiments, comprise several servers or computing devices performing interconnected and/or distributed functions. Despite the many arrangements contemplated herein, resource operation management server 210 is shown and described herein as a single computing device to avoid unnecessarily overcomplicating the disclosure.

Resource operation management server 210 can communicate with one or more client devices 101A-101N via communications network 102. Communications network 102 may include any one or more wired and/or wireless communication networks including, for example, a wired or wireless local area network (LAN), personal area network (PAN), metropolitan area network (MAN), wide area network (WAN), or the like, as well as any hardware, software and/or firmware required for implementing the one or more networks (e.g., network routers, switches, hubs, etc.). For example, communications network 102 may include a cellular telephone, mobile broadband, long term evolution (LTE), GSM/EDGE, UMTS/HSPA, IEEE 802.11, IEEE 802.16, IEEE 802.20, Wi-Fi, dial-up, and/or WiMAX network. Furthermore, the communications network 102 may include a public network, such as the Internet, a private network, such as an intranet, or combinations thereof, and may utilize a variety of networking protocols now available or later developed including, but not limited to TCP/IP based networking protocols. For instance, the networking protocol may be customized to suit the needs of the resource operation management and collaboration system 200.

The resource operation insight data repository 215 may be stored by any suitable storage device configured to store some or all of the information described herein (e.g., memory 201 of the resource operation management server 210 or a separate memory system separate from the resource operation management server 210, such as one or more database systems, backend data servers, network databases, cloud storage devices, or the like provided by another device (e.g., online application or 3rd party provider), such as a Network Attached Storage (NAS) device or devices, or as a separate database server or servers. The resource operation insight data repository 215 may comprise data received from the resource operation management server 210 (e.g., via a memory 201 and/or processor(s) 202), and the corresponding storage device may thus store this data. The resource operation insight data repository 215 includes information accessed and stored by the resource operation management server 210 to facilitate the operations of the resource operation management and collaboration system 200. As such, the resource operation insight data repository 215 may include, for example, without limitation, data associated with resource container units including resource container unit items such as target resource container unit data, resource container unit title data, resource container unit progress data, resource container unit owner data, resource container unit target completion data, resource sub-container unit data, resource container unit key result data, resource container unit status data, resource container unit qualitative update data, resource container unit risk data, resource container unit financial data, resource container unit team data, hierarchical resource container unit data, timestamp data, and/or the like. Still further, the resource operation insight data repository 215 may include data from a number of disparate data sources including, without limitation, agile frameworks (e.g., agile software development tools such as software development tool 106A) and non-agile frameworks (e.g., enterprise financial planning tools such as financial planning tool 108 and HR tools such as HR tool 109).

Financial planning tool 108 may be any one or more underlying financial planning tools (e.g., Jira Work Management®, Jira Align®, etc.). In some embodiments, one or more financial planning tools 108 may be based on a non-agile framework. Such financial planning tools 108 may be enterprise tools or non-enterprise (e.g., third party) tools.

HR tool 109 may be any one or more underlying human resources tools. In some embodiments, one or more HR tools 109 may be based on a non-agile framework. Such HR tools 109 may be enterprise tools or non-enterprise (e.g., third party) tools.

Software development tools 106A-106N may be any one or more underlying software development tools and/or project management tools (e.g., Jira®, Bitbucket®, etc.). In some embodiments, one or more software development tools 106A-106B may be based on an agile framework. Such software development tools 106A-106N may be enterprise tools or non-enterprise (e.g., third party) tools.

The client devices 101A-101N may be implemented as any computing device as defined above. Electronic data received by the resource operation management server 210 from the client devices 101A-101N may be provided in various forms and via various methods. For example, the client devices 101A-101N may include desktop computers, laptop computers, smartphones, netbooks, tablet computers, wearables, and/or other networked device, that may be used for any suitable purpose in addition to presenting the resource operational interface to a user (e.g., business leader) and otherwise providing access to the resource operation management and collaboration system 200. The depiction in FIG. 1 of “N” client devices is merely for illustration purposes. According to some embodiments, the client devices 101A-101N may be configured to display an interface on a display of the client device for viewing, creating, editing, and/or otherwise interacting with at least one resource operational interface, which may be provided by the resource operation management and collaboration system 200. According to further embodiments, the client devices 101A-101N may be configured to generate and/or display one or more resource container unit aggregation insight map interface(s), resource container unit interface component(s), detailed resource container unit insight interface component(s), visual emphasis element(s), and/or the like.

In embodiments where a client device 101A-101N is a mobile device, such as a smartphone or tablet, the client device 101A-101N may execute an “app” to interact with the resource operation management and collaboration system 200. Such apps are typically designed to execute on mobile devices, such as tablets or smartphones. For example, an app may be provided that executes on mobile device operating systems such as iOS®, Android®, or Windows®. These platforms typically provide frameworks that allow apps to communicate with one another and with particular hardware and software components of mobile devices. The mobile operating systems named above each provide frameworks for interacting with, for example, wired and wireless network interfaces, user contacts, and other applications. Communication with hardware and software modules executing outside of the app is typically provided via application programming interfaces (APIs) provided by the mobile device operating system. Additionally, or alternatively, the client device 101A-101N may interact with the resource operation management and collaboration system 200 via a web browser. As yet another example, the client devices 101A-101N may include various hardware or firmware designed to interface with the resource operation management and collaboration system 200.

### Example Apparatus for Implementing Embodiments of the Present Disclosure

FIG. 2 illustrates an example resource operation management server 210 in accordance with at least some example embodiments of the present disclosure. In accordance with some example embodiments, resource operation management server 210 may include various components, modules, circuitries, or means, some or all of which may be also or instead be included in one or more client device(s) 101A-101N. In accordance with some example embodiments, resource operation management server 210 may be configured, using one or more of the sets of circuitry embodying memory 201, processor 202, input/output circuitry 203, communications circuitry 204, and/or resource operation insight circuitry 205 to execute and perform the operations described herein. In some embodiments, resource operation insight circuitry 205 is included in resource operation management server 210 and/or client device 101A, the circuitry configured to facilitate the functionality discussed herein regarding generating, outputting, and/or updating resource operational interface(s), resource container unit aggregation insight map interface(s), resource container unit interface component(s), detailed resource container unit insight interface component(s), visual emphasis element(s), and/or the like. It will be appreciated that while various references are made herein to a “server” or “servers” such references are not intended to implicate monolithic servers. Rather, as will be apparent to one of ordinary skill in the art in view of this disclosure, the operations and functionality attributed to any disclosed server may be performed in a cloud computing environment and thereby completed by multiple servers.

Although the use of the term “circuitry” as used herein with respect to components 201-205 are described in some cases with respect to functional limitations, it should be understood that the particular implementations necessarily include the use of particular hardware configured to perform the functions associated with the respective circuitry as described herein. It should also be understood that certain of these components 201-205 may include similar or common hardware. For example, two sets of circuitry may both leverage use of the same processor(s), network interface(s), storage medium(s), and/or the like to perform their associated functions, such that duplicate hardware is not required for each set of circuitry. The use of the term “circuitry” with respect to components of the apparatuses described herein should therefore be understood to include particular hardware configured to perform the functions associated with the respective components or particular circuitry as described herein.

The term “circuitry” should also be understood, in some embodiments, to include software for configuring the hardware. For example, in some embodiments, “circuitry” may include processing circuitry, storage media, network interfaces, input/output devices, and the like. In some embodiments, such as in examples where circuitry is included with resource operation management server 210, other elements of the resource operation management server 210 may provide or supplement the functionality of particular circuitry. For example, the processor 202 may provide processing functionality, the memory 201 may provide storage functionality, the communications circuitry 204 may provide network interface functionality, and the like.

In some embodiments, the processor 202 (and/or co-processor or any other processing circuitry assisting or otherwise associated with the processor) may be in communication with the memory 201 via a bus for passing information among components of, for example, resource operation management server 210. The memory 201 is non-transitory and may include, for example, one or more volatile and/or non-volatile memories, or some combination thereof. In other words, for example, the memory 201 may be an electronic storage device (e.g., a computer readable storage medium). The memory 201 may be configured to store information, data, content, applications, instructions, or the like, for enabling an apparatus, e.g., resource operation management server 210, to carry out various functions in accordance with example embodiments of the present disclosure.

Although illustrated in FIG. 2 as a single memory, memory 201 may comprise a plurality of memory components. The plurality of memory components may be embodied on a single computing device or distributed across a plurality of computing devices. In various embodiments, memory 201 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. Memory 201 may be configured to store information, data, applications, instructions, or the like for enabling resource operation management server 210 to carry out various functions in accordance with example embodiments discussed herein. For example, in at least some embodiments, memory 201 is configured to buffer data for processing by processor 202. Additionally or alternatively, in at least some embodiments, memory 201 is configured to store program instructions for execution by processor 202. Memory 201 may store information in the form of static and/or dynamic information. This stored information may be stored and/or used by resource operation management server 210 during the course of performing its functionalities.

Processor 202 may be embodied in a number of different ways and may, for example, include one or more processing devices configured to perform independently. Additionally or alternatively, processor 202 may include one or more processors configured in tandem via a bus to enable independent execution of instructions, pipelining, and/or multithreading. Processor 202 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. The use of the term “processing circuitry” may be understood to include a single core processor, a multi-core processor, multiple processors internal to the apparatus, and/or remote or “cloud” processors. Accordingly, although illustrated in FIG. 2 as a single processor, in some embodiments, processor 202 comprises a plurality of processors. The plurality of processors may be embodied on a single computing device or may be distributed across a plurality of such devices collectively configured to function as resource operation management server 210. The plurality of processors may be in operative communication with each other and may be collectively configured to perform one or more functionalities of resource operation management server 210 as described herein.

In an example embodiment, processor 202 is configured to execute instructions stored in the memory 201 or otherwise accessible to processor 202. Alternatively or additionally, the processor 202 may be configured to execute hard-coded functionality. As such, whether configured by hardware or software methods, or by a combination thereof, the processor 202 may represent an entity (e.g., physically embodied in circuitry) capable of performing operations according to an embodiment of the present disclosure while configured accordingly. Alternatively, as another example, when the processor 202 is embodied as an executor of software instructions, the instructions may specifically configure processor 202 to perform one or more algorithms and/or operations described herein when the instructions are executed. For example, these instructions, when executed by processor 202, may cause resource operation management server 210 to perform one or more of the functionalities of resource operation management server 210 as described herein.

In some embodiments, input/output circuitry 203 may, in turn, be in communication with processor 202 to provide an audible, visual, mechanical, or other output and/or, in some embodiments, to receive an indication of an input. In that sense, input/output circuitry 203 may include means for performing analog-to-digital and/or digital-to-analog data conversions. Input/output circuitry 203 may include support, for example, for a display, touchscreen, keyboard, button, click wheel, mouse, joystick, an image capturing device (e.g., a camera), motion sensor (e.g., accelerometer and/or gyroscope), microphone, audio recorder, speaker, biometric scanner, and/or other input/output mechanisms. Input/output circuitry 203 may comprise a user interface (e.g., resource operational interface, etc.) and may comprise a web user interface, a mobile application, a kiosk, or the like. The processor 202 and/or user interface circuitry comprising the processor 202 may be configured to control one or more functions of a display or one or more user interface elements through computer program instructions (e.g., software and/or firmware) stored on a memory accessible to the processor 202 (e.g., memory 201, and/or the like). In some embodiments, aspects of input/output circuitry 203 may be reduced when implemented also or instead as an end-user machine or other type of device designed for complex user interactions (i.e., client device 101). In some embodiments (like other components discussed herein), input/output circuitry 203 may even be eliminated from resource operation management server 210. Alternatively, in some embodiments, at least some aspects of input/output circuitry 203 may be embodied on an apparatus used by a user (e.g., business leader, team leader, PgM, and/or the like) that is in communication with resource operation management server 210. Input/output circuitry 203 may be in communication with memory 201, communications circuitry 204, and/or any other component(s), such as via a bus. Although more than one input/output circuitry and/or other component can be included in resource operation management server 210, only one is shown in FIG. 2 to avoid overcomplicating the disclosure (e.g., like the other components discussed herein).

Communications circuitry 204 may be any means such as a device or circuitry embodied in either hardware or a combination of hardware and software that is configured to receive and/or transmit data from/to a network and/or any other device, circuitry, or module in communication with resource operation management server 210. In this regard, the communications circuitry 204 may include, for example, a network interface for enabling communications with a wired or wireless communication network. Communications circuitry 204 may be configured to receive and/or transmit any data that may be stored by memory 201 using any protocol that may be used for communications between computing devices. For example, the communications circuitry 204 may include one or more network interface cards, antennae, transmitters, receivers, buses, switches, routers, modems, and supporting hardware and/or software, and/or firmware/software, or any other device suitable for enabling communications via a network. Additionally, or alternatively, the communication interface may include the circuitry for interacting with the antenna(s) to cause transmission of signals via the antenna(s) or to handle receipt of signals received via the antenna(s). These signals may be transmitted by the resource operation management server 210 using any of a number of wireless personal area network (PAN) technologies, such as Bluetooth® v1.0 through v3.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols. Communications circuitry 204 may additionally or alternatively be in communication with the memory 201, input/output circuitry 203 and/or any other component of resource operation management server 210, such as via a bus.

In some embodiments, resource operation insight circuitry 205 may also or instead be included and configured to perform the functionality discussed herein related to analyzing and/or aggregating disparate data sets from the resource operation management and collaboration system 200, identifying one or more express linkages in such data sets, determining and/or generating one or more inferred linkages in such data sets, and/or generating, outputting, and/or updating resource operational interface(s), resource container unit aggregation insight map interface(s), resource container unit interface component(s), detailed resource container unit insight interface component(s), visual emphasis element(s), and/or the like. Resource operation insight circuitry 205 includes hardware components and/or software configured to support disparate data aggregation, linkage(s) formation, and interface component functionality, features, and/or services of the resource operation management server 210 and/or client device 101A. The resource operation insight circuitry 205 may utilize processing circuitry, such as the processor 202, to perform its corresponding operations, and may utilize memory 201 to store collected information. The resource operation insight circuitry 205 may send and/or receive data from resource operation insight data repository 215. In some implementations, the sent and/or received data may include identifier(s) (e.g., user identifier, project identifier, portfolio identifier, enterprise identifier, resource container unit identifier, and/or the like), data associated with resource container units including, for example, resource container unit items such as target resource container unit data, resource container unit title data, resource container unit progress data, resource container unit owner data, resource container unit target completion data, resource sub-container unit data, resource container unit key result data, resource container unit status data, resource container unit qualitative update data, resource container unit risk data, resource container unit financial data, resource container unit team data, hierarchical resource container unit data, timestamp data, and associated data that is configured for association with, for example, generating, outputting, and/or updating resource operational interface(s), resource container unit aggregation insight map interface(s), resource container unit interface component(s), detailed resource container unit insight interface component(s), visual emphasis element(s), and/or the like.

It should also be appreciated that, in some embodiments, the resource operation insight circuitry 205 may include a separate processor, specially configured field programmable gate array (FPGA), or application specific interface circuit (ASIC) to perform its corresponding functions. For example, in some embodiments, some or all of the functionality of resource operation insight circuitry 205 may be performed by processor 202. In this regard, some or all of the example processes and algorithms discussed herein can be performed by at least one processor 202 and/or resource operation insight circuitry 205. For example, non-transitory computer readable storage media can be configured to store firmware, one or more application programs, and/or other software, which include instructions and other computer-readable program code portions that can be executed to control processors of the components of resource operation management server 210 to implement various operations, including the examples shown herein. As such, a series of computer-readable program code portions may be embodied in one or more computer program products and can be used, with a device, resource operation management server 210, database, and/or other programmable apparatus, to produce the machine-implemented processes discussed herein. It is also noted that all or some of the information discussed herein can be based on data that is received, generated and/or maintained by one or more components of the resource operation management server 210, client device 101A, etc. In some embodiments, one or more external systems (such as a remote cloud computing and/or data storage system) may also be leveraged to provide at least some of the functionality discussed herein.

As described above and as will be appreciated based on this disclosure, embodiments of the present disclosure may be configured as systems, methods, apparatuses, computing devices, personal computers, servers, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions embodied in the computer-readable storage medium (e.g., computer software stored on a hardware device). Any suitable computer-readable storage medium may be utilized including non-transitory hard disks, CD-ROMs, flash memory, optical storage devices, or magnetic storage devices.

As will be appreciated, any such computer program instructions and/or other type of code may be loaded onto a computer, processor or other programmable apparatus's circuitry to produce a machine, such that the computer, processor, or other programmable circuitry that execute the code on the machine creates the means for implementing various functions, including those described herein in connection with the components of resource operation management server 210.

The computing systems described herein can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

In various embodiments of the present disclosure, an apparatus (e.g., resource operation management server 210) may be configured to analyze and/or aggregate disparate data sets from the resource operation management and collaboration system 200 in order to identify one or more express linkages in such data sets and/or determine and generate one or more inferred linkages in such data sets. In a non-limiting contextual example, the resource operation management server 210 may be configured to identify express linkages such as from software development tool 106 which provides data indicating an express linkage between Bob and the project (Project Alpha) Bob is working on, that Project Alpha has a current progress of 74% complete, and that Bob is working on Project Alpha with 4 identified team members).

In some embodiments, during the aggregation process of such disparate data sets (e.g. from different tools, frameworks, owners, etc.), inferred linkages may be developed. Continuing with such non-limiting contextual example, the resource operation management server 210 may be configured to infer or predict other linkages by aggregating and analyzing disparate data from, for example, HR tool 109, which provides data indicating that Bob reports up to Frank such that Bob is part of Organization Beta, and from financial planning tool 108, which provides data indicating that Organization Beta has a certain spend budget and Frank is responsible for such certain spend budget of Organization Beta. Organization Beta may comprise six teams and each team, which may be overlapping or varying team members, is working on 5+ projects in a variety of software development tools, with each such project being at a different phase of development. The resource operation management server 210 may be configured to infer, for example, costs that might flow down from that certain spend budget to the Project Alpha that Bob is working on, and such inferred linkage is only determined based on such aggregated and analyzed disparate data. Further details regarding aggregating disparate data sets, identifying one or more express linkages, and determining and/or generating one or more inferred linkages are described in commonly-owned U.S. patent application Ser. No. 18/657,030, which was filed on May 7, 2024, and is entitled “APPARATUS, METHOD, AND COMPUTER PROGRAM PRODUCT FOR OUTPUTTING A RESOURCE DEVELOPMENT GENERATION INTERFACE COMPONENT TO A RESOURCE OPERATIONAL INTERFACE”, which patent application is incorporated by reference herein in its entirety. In some further embodiments, the resource operation management server 210 may be configured to receive input from the user validating/approving or overriding/disapproving such inferred linkages.

In various embodiments of the present disclosure, an apparatus (e.g., resource operation management server 210) may be configured to generate, output, and/or update a resource container unit aggregation insight map interface in a resource operation management and collaboration system 200. FIGS. 3A and 3B each illustrate an example resource container unit aggregation insight map interface 305 structured in accordance with various embodiments of the subject disclosure. In a non-limiting example, the depicted resource container unit aggregation insight map interface 305 in FIG. 3A is rendered to the resource operations interface 300 in association with a goals-first view, thereby visualizing such aggregated disparate data and express and inferred linkages in such a goals-first view. In other words, such a goals-first view may be configured to depict goals, child or sub-goals, and information attached to each of those goals and child/sub-goals related to, for example, budgets, how many people are working on that particular goal, progress and status of those goals and child/sub-goals. In particular, an enterprise goal of “boosting global guest retention by 15% through unique experiences.” The depicted resource container unit aggregation insight map interface 305 in FIG. 3A in goals-first view comprises a plurality of resource container unit interface components 301 which correspond to child or sub-goal container units associated with such enterprise goal (e.g., “Launch standards for high-quality content contributions”, “Build database of community experts”, “Increase the number of city guides for South America”, “Launch content portal for external content contributors”, “Set cadence for publication of local guides”, “Create strategy for engaging with experts on social media”). The depicted resource container unit interface components 301 surface metrics and aggregated data associated with such enterprise goal and child or sub-goals (e.g., “Spend $3B”, “Sub-goals 4”, “Key results 2”, etc.).

In some embodiments, a resource container unit aggregation insight map interface 305 may display a visual linkage element 310 (e.g., a line, arrow, etc.) that visually depicts a hierarchical mapping arrangement, such as a parent-child hierarchical mapping arrangement. For example, as depicted in FIG. 3A, a visual linkage element 310 is depicted between the resource container unit interface component 301 associated with the enterprise goal (e.g., “Boost global guest retention by 15% through unique experiences”) and at least one of its child or sub-goals depicted by a second resource container unit interface component 301 (e.g., “Launch standards for high quality content distributions”). In some embodiments, a resource container unit aggregation insight map interface 305 may display a plurality of visual linkage elements 310 showing the full or entire relationship (e.g., from upper-most parent to lowest child resource container unit). For example, as depicted in FIG. 3A, the sub-goal depicted by the resource container unit interface component 301 (e.g., “Launch standards for high quality content distributions”) is visually connected via another visual linkage element 310 to the sub-goal thereto depicted by the resource container unit interface component 301 (e.g., “Launch content portal for external content contributors”). Such hierarchical mapping arrangement may depict a link, connection, relationship, association, bond, and/or the like.

In another non-limiting example, the depicted resource container unit aggregation insight map interface 305 in FIG. 3B is rendered to the resource operations interface 300 in association with an area of responsibility view, thereby visualizing such aggregated disparate data and express and inferred linkages in a different way. In particular, the depicted resource container unit aggregation insight map interface 305 in FIG. 3B an area of responsibility view comprises a plurality of resource container unit interface components 301 which correspond to program and initiative container units (e.g., work container units) associated with an enterprise portfolio of “international experiences.” (e.g., “South American guidebook”, “Bespoke itineraries”, “Online experiences”, “Argentine city guide”, “Brazilian city guide”, “Recommendations engine”). For example, a certain user or team of users may be responsible for (e.g., “owns”) such enterprise portfolio of “international experiences” and the area of responsibility view visualizes or surfaces such aggregated disparate data and express and inferred linkages such that the primary dimension is a significant area of responsibility. The present disclosure contemplates other views such that the aggregated disparate data and express and inferred linkages are visualized or surfaced based on different primary dimensions, such as, but not limited to, budget allocation (e.g., tying and visualizing agile work to budget allocations across the enterprise) and is not limited to the depicted goals-first view and area of responsibility view.

Although the example resource container unit aggregation insight map interfaces 305 are depicted as being arranged or rendered in a main pane of the resource operations interface 300, such depictions are for purposes of illustration and not of limitation and other suitable variations of arranging or rendering the interface components, panes, and panels to the resource operations interface 300 are also contemplated by this disclosure as will be apparent to one of ordinary skill in the art.

Turning to FIG. 4A, an example resource container unit interface component 401 structured in accordance with various embodiments of the subject disclosure is illustrated. A resource container unit interface component 401 may comprise one or more of resource container unit title data, resource container unit progress data, resource container unit owner data, resource sub-container unit data, resource container unit key result data, resource container unit target completion data, resource container unit status data, resource container unit qualitative update data, resource container unit risk data, resource container unit financial data, resource container unit team data, and/or the like. In a non-limiting example, the resource container unit interface component 401 depicted in FIG. 4A comprises a plurality of resource container unit items, including resource container unit progress data, resource container unit title data (“Launch standards for high-quality content contributions”), resource container unit financial data (“Spend: $1.6B”), resource container unit status data (“At risk”), resource container unit risk data (“1 escalated risk”), resource sub-container unit data (“Sub-goals: 2”), and resource container unit key result data (“Key Results: 2”). Any one or more of the resource container unit items may be determined as a result of the express linkages and linkages inferred from the aggregated disparate data that is analyzed by, for example, the resource operation management server 210. In a non-limiting example, the resource container unit financial data (“Spend: $1.6B”) in FIG. 4A is determined based on externally aggregated data from inferred linkages across, for example, a financial planning tool 108, an HR tool 109, and a software development tool 106.

One or more of the resource container unit items may be associated with visual emphasis elements. In the non-limiting example depicted in FIG. 4A, a first visual emphasis element is based on the resource container unit progress data, such that the first visual emphasis element is configured to visually compare current resource container unit progress data to target resource container unit data. That is, the resource container unit interface component 401 depicted in FIG. 4A includes a progress circle chart indicating that only 44% of the target progress goal is completed. This progress circle chart is orange to visually indicate the slower than anticipated progress. The data underlying this analysis may originate from, for example, agile software project framework or applications (e.g., software development tools and project management tools 106A-106N).

A second emphasis element depicted in FIG. 4A is based on the resource container unit status data, the second visual emphasis element being configured to visually depict a current resource container unit status. That is, the resource container unit interface component 401 depicted in FIG. 4A includes a resource container unit status data of “At risk” in orange text to indicate that the goal corresponding to the resource container unit interface component 401 is “at risk”. The data underlying this analysis may originate from, for example, agile software project framework or applications and/or non-agile frameworks (e.g., software development tools and project management tools 106A-106N and/or financial planning tool 108 and/or HR tool 109).

A third emphasis element depicted in FIG. 4A is based on the resource container unit risk data, the third visual emphasis element being configured to visually depict a current resource container risk data. That is, the resource container unit interface component 401 depicted in FIG. 4A includes resource container risk data identifying “1 elevated risk” in orange text with a warning symbol to indicate that the goal corresponding to the resource container unit interface component is subject to one escalated risk. The data underlying this analysis may originate from, for example, non-agile frameworks (e.g., financial planning tool 108).

The resource container unit interface component 401 depicted in FIG. 4A exposes a first or summary level of information. In a non-limiting example, the user may want to see additional details for a selected body of work to gain more context, such as about money and teams to know whether they are on track to deliver a certain return on investment (ROI=value delivered less resource costs of money and teams). The user may hover over, click on the “carrot” to expand, or otherwise interact with the selected resource container unit interface component 401 in FIG. 4A in order to expose a second level of information or detailed resource container unit insight interface component 401 as depicted in FIG. 4B.

Turning to FIG. 5A, another example resource container unit interface component 501 structured in accordance with various embodiments of the subject disclosure is illustrated. A resource container unit interface component 501 may comprise one or more of resource container unit title data, resource container unit progress data, resource container unit owner data, resource sub-container unit data, resource container unit key result data, resource container unit target completion data, resource container unit status data, resource container unit qualitative update data, resource container unit risk data, resource container unit financial data, resource container unit team data, and/or the like. In a non-limiting example, the resource container unit interface component 501 depicted in FIG. 5A comprises a plurality of resource container unit items, including resource container unit progress data, resource container unit title data (“South American guidebook”), resource container unit target completion data (“July 2024”), resource container unit status data (“ON TRACK”), and resource container unit owner data (“Fran Perez”).

One or more of the resource container unit items may be associated with visual emphasis elements. In the non-limiting example depicted in FIG. 5A, a visual emphasis element is based on the resource container unit progress data, such that the visual emphasis element is configured to visually compare current resource container unit progress data to target resource container unit data. That is, the resource container unit interface component 501 depicted in FIG. 5A includes a progress line chart and alphanumeric text indicating that only 66% of the target progress goal is completed. This progress line chart visually indicates the relative amounts of underlying items that are in progress (e.g., in green), completed (e.g., in gray), not yet started or overdue (e.g., in red), not yet started or to be completed (e.g., in orange). The data underlying this analysis may originate from, for example, agile software project framework or applications (e.g., software development tools and project management tools 106A-106N).

The resource container unit interface component 501 depicted in FIG. 5A exposes a first or summary level of information. In a non-limiting example, the user may want to see additional details for a selected body of work to gain more context, such as information about goals that are associated with the selected program. The user may hover over, click on the “carrot” to expand, or otherwise interact with the selected resource container unit interface component 401 in FIG. 5A in order to expose a second level of information or detailed resource container unit insight interface component 501 as depicted in FIG. 5B (e.g., depicting three goals of the program container unit and a visual status indication of whether each goal is “on track” or “at risk”).

Such examples are for purposes of illustration and not of limitation and other suitable variations of depicting the resource container unit items and the various resource container unit interface components are also contemplated by this disclosure as will be apparent to one of ordinary skill in the art.

### Example Operations Performed

Having described example systems and apparatuses and exemplary circuitry in accordance with various embodiments of the present disclosure, example process of the disclosure will now be discussed. It will be appreciated that each of the flowcharts depicts an example computer-implemented process that is performable by one or more of the apparatuses, systems, devices, and/or computer program products described herein, for example utilizing one or more of the specially configured components thereof. It will further be appreciated that the example apparatuses, systems, devices, and/or computer program products may proceed to generate, output, and/or update resource operational interface(s), resource container unit aggregation insight map interface(s), resource container unit interface component(s), detailed resource container unit insight interface component(s), visual emphasis element(s), and/or the like in a resource operation management and collaboration system 200 in a number of different ways.

The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally, or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

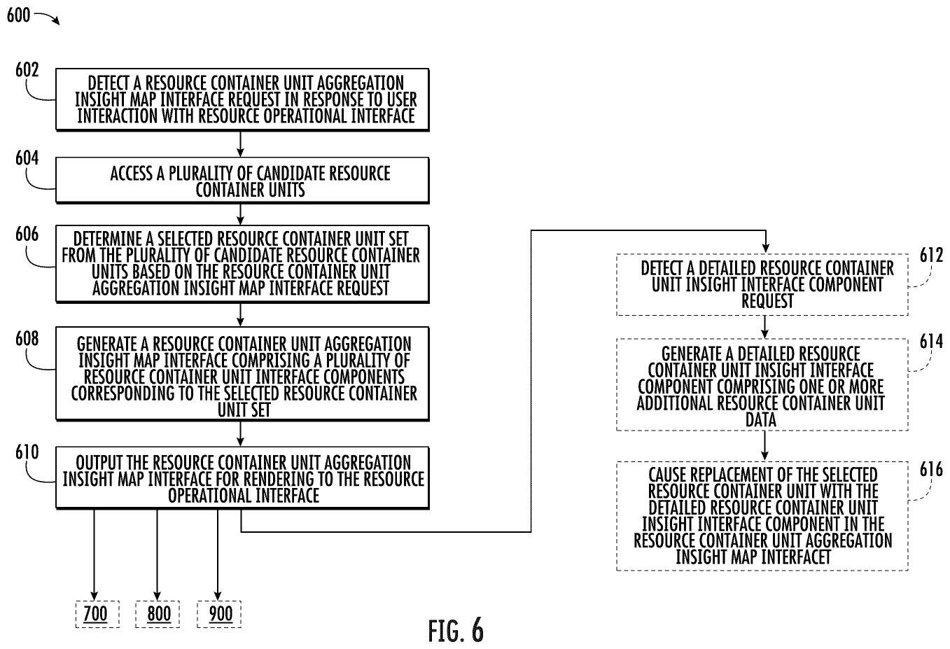

FIG. 6 is a flowchart broadly illustrating a series of operations or process blocks that are executed or performed to output a resource container unit aggregation insight interface for rendering to a resource operational interface in accordance with some example embodiments of the present disclosure. In some embodiments, the method 600 is embodied by computer program code stored on a non-transitory computer-readable storage medium of a computer program product configured for execution to perform the process as depicted and described. In this regard, in some such embodiments, the resource operation management server 210 is specially configured by computer-coded instructions (e.g., computer program instructions) stored thereon, for example in the memory 201 and/or another component depicted and/or described herein and/or otherwise accessible to the resource operation management server 210, for performing the operations as depicted and described. Alternatively, or additionally, in some embodiments, the method 600 is performed by one or more specially configured computing devices, such as the resource operation management server 210 alone or in communication with one or more other component(s), device(s), system(s), and/or the like. For purposes of simplifying the description, the method 600 is described as performed by and from the perspective of the resource operation management server 210. In this regard, performance of the operations may invoke one or more of memory 201, processor 202, input/output circuitry 203, communications circuitry 204, and/or resource operation insight circuitry 205.

In the embodiment illustrated in FIG. 6, the flowchart illustrates method 600 which begins at block 602. At block 602, the resource operation management server 210 may include means, such as the memory 201, processor 202, input/output circuitry 203, communications circuitry 204, and/or resource operation insight circuitry 205, or a combination thereof, to detect a resource container unit aggregation insight map interface request. In some embodiments, resource container unit aggregation insight map interface request is detected in response to user interaction with a resource operational interface. In still further embodiments, the resource container unit aggregation insight map interface request may be associated with a selected resource container unit identifier.

Such a resource container unit aggregation insight map interface request may be associated with, for example, a top-level leader wanting a highly visual way to see all work happening in order to validate the company is executing what he or she believes is the most valuable work. In a non-limiting example, a selected resource container unit identifier may correspond to a CEO's long term strategy and the resource container unit aggregation insight map interface request may be a request to output a resource container unit aggregation insight map interface illustrating how all work rolls up to support such long term strategy. As another non-limiting example, the resource container unit aggregation insight map interface request may be a request by a CFO to output a resource container unit aggregation insight map interface illustrating where budgets have been allocated down to lowest levels of the company/enterprise. In another non-limiting example, the resource container unit aggregation insight map interface request may be a request by a VP to output a resource container unit aggregation insight map interface illustrating all work where his or her headcount has been allocated. In still another non-limiting example, the resource container unit aggregation insight map interface request may be a request by a PgM to output a resource container unit aggregation insight map interface illustrating the company's/enterprise's top goals and the resources assigned to supporting work underneath each top goal.

At block 604, the resource operation management server 210 includes means, such as the memory 201, processor 202, input/output circuitry 203, communications circuitry 204, and/or resource operation insight circuitry 205, or a combination thereof, to access a plurality of candidate resource container units. For example, in some embodiments, accessing a plurality of candidate resource container units may accessing a data repository, such as resource operation insight data repository 215.

At block 606, the resource operation management server 210 includes means, such as the memory 201, processor 202, input/output circuitry 203, communications circuitry 204, and/or resource operation insight circuitry 205, or a combination thereof, to determine a selected resource container unit set from the plurality of candidate resource container units. For example, in some embodiments, determining a selected resource container unit set from the plurality of candidate resource container units may include the resource operation management server 210 generating a query that is submitted to a data repository, such as resource operation insight data repository 215. Such query may be based on, for example, a selected resource container unit identifier associated with the resource container unit aggregation insight map interface request. In such embodiments, the resource container units returned by the query may form the selected resource container unit set.

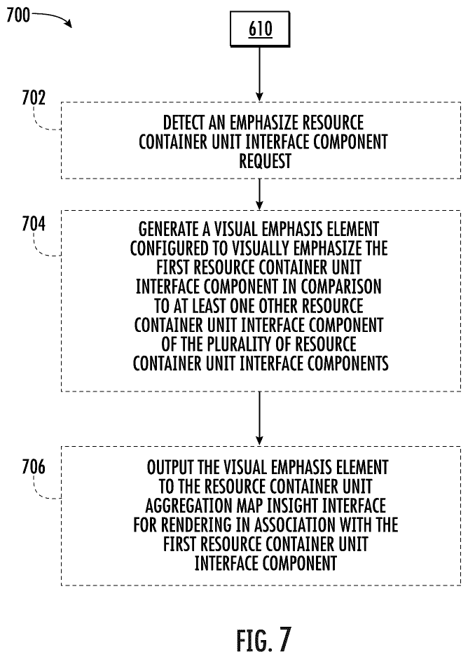

At block 608, the resource operation management server 210 includes means, such as the memory 201, processor 202, input/output circuitry 203, communications circuitry 204, and/or resource operation insight circuitry 205, or a combination thereof, to generate a resource container unit aggregation insight map interface comprising a plurality of resource container unit interface components corresponding to the selected resource container unit set. In some embodiments, the resource container unit aggregation insight map interface is configured to visually depict at least two of the resource container unit interface components in a hierarchical mapping arrangement. The process for visually depicting at least two of the resource container unit interface components in a hierarchical mapping arrangement is described in greater detail below with respect to FIG. 7.

In some embodiments, each of the resource container unit interface components comprises one or more of resource container unit title data, resource container unit progress data, resource container unit owner data, resource sub-container unit data, resource container unit key result data, resource container unit target completion data, resource container unit status data, resource container unit qualitative update data, resource container unit risk data, resource container unit financial data, or resource container unit team data.

At block 610, the resource operation management server 210 includes means, such as the memory 201, processor 202, input/output circuitry 203, communications circuitry 204, and/or resource operation insight circuitry 205, or a combination thereof, to output the resource container unit aggregation insight interface for rendering to the resource operational interface. In some embodiments, a first resource container unit interface component of the resource container unit aggregation insight map interface comprises a visual emphasis element based on one or more resource container unit items. For example, in a non-limiting illustration, the resource container unit interface component depicted in FIG. 4A comprises three visual emphasis elements. The first visual emphasis element is based on the resource container unit progress data, the first visual emphasis element being configured to visually status compare current resource container unit progress data to target resource container unit data. That is, the resource container unit interface component depicted in FIG. 4A includes a progress circle chart indicating that only 44% of target progress goal is completed. This progress circle chart is orange to visually indicate the slow progress. The data underlying this analysis may be from, for example, agile software project framework or applications. The second emphasis element depicted in FIG. 4A is based on the resource container unit status data, the second visual emphasis element being configured to visually depict a current resource container unit status. That is, the resource container unit interface component depicted in FIG. 4A includes a resource container unit status data of “At risk” in orange text to indicate that the goal corresponding to the resource container unit interface component is “at risk”. The data underlying this analysis may be from, for example, agile software project framework or applications and/or non-agile frameworks. In some embodiments, such resource container unit status data may be identified or manually set by an end user. Additionally or alternatively, in some embodiments, the resource operation management server 210 may be configured to infer such resource container unit status data based on aggregation and analysis of disparate data sets from, for example, software development tool 106, financial planning tool 108, and/or HR tool 109. In still further embodiments and a non-limiting example, the resource operation management server 210 may leverage one or more artificial intelligence tools to review such disparate data sets and propose a resource container unit status data which an end user may be able to validate or override.

The third emphasis element depicted in FIG. 4A is based on the resource container unit risk data, the third visual emphasis element being configured to visually depict a current resource container risk data. That is, the resource container unit interface component depicted in FIG. 4A includes a resource container risk data identifying “1 elevated risk” in orange text with a warning symbol to indicate that the goal corresponding to the resource container unit interface component is subject to one escalated risk. The data underlying this analysis may be from, for example, non-agile frameworks. This visual emphasis element may be used to surface one or more additional resource container unit data as described with respect to optional block 614.

As illustrated at optional block 612, in some embodiments, the resource operation management server 210 includes means, such as the memory 201, processor 202, input/output circuitry 203, communications circuitry 204, and/or resource operation insight circuitry 205, or a combination thereof, to detect a detailed resource container unit insight interface component request. For example, in some embodiments, the resource container unit aggregation insight map interface generated in block 608 and output in block 610 may comprise one or more resource container unit interface components that expose a first or summary level of information, such as depicted in FIG. 4A. In a non-limiting example, the user may want to see additional details for a selected body of work to gain more context, such as about money and teams to know whether they are on track to deliver a certain return on investment (ROI=value delivered less resource costs of money and teams). At optional block 612, the detailed resource container unit insight interface component request may be detected in response to user interaction with such first or selected resource container unit interface component of the resource container unit aggregation insight map interface. In the non-limiting illustration depicted in FIG. 4A, the user may hover over, click on the “carrot” to expand, or otherwise interact with the selected resource container unit interface component 401 in order to initiate a detailed resource container unit insight interface component request.

As illustrated at optional block 614, in some embodiments, the resource operation management server 210 includes means, such as the memory 201, processor 202, input/output circuitry 203, communications circuitry 204, and/or resource operation insight circuitry 205, or a combination thereof, to generate a detailed resource container unit insight interface component comprising one or more additional resource container unit data. For example, in the non-limiting example depicted in FIG. 4B, detailed resource container unit insight interface component may include additional resource container unit data, such as resource container unit risk data providing further explanation of the “1 escalated risk” (e.g., “Revenue from new markets less than forecasted”) and/or resource container unit qualitative update data providing a snippet of information from the latest qualitative update for that selected resource container unit (an update from user “Fran Perez” on “Friday” indicating “We're planning to launch standards to up-level of content contributions made by local experts in order to set a higher bar for content quality”).

As illustrated at optional block 616, in some embodiments, the resource operation management server 210 includes means, such as the memory 201, processor 202, input/output circuitry 203, communications circuitry 204, and/or resource operation insight circuitry 205, or a combination thereof, to cause replacement of the selected resource container unit with the detailed resource container unit insight interface component in the resource container unit aggregation insight map interface.

Turning now to FIG. 7, a flowchart broadly illustrates a series of optional operations or process blocks that are executed or performed to output a visual emphasis element to the resource container unit aggregation insight map interface in accordance with some example embodiments of the present disclosure. Subsequent to outputting the resource container unit aggregation insight interface for rendering to the resource operational interface in block 610, in some embodiments, the resource operation management server 210 includes means, such as the memory 201, processor 202, input/output circuitry 203, communications circuitry 204, and/or resource operation insight circuitry 205, or a combination thereof, to detect an emphasize resource container unit interface component request as illustrated at optional block 702. For example, in a non-limiting illustration, a PgM user may elect to “call attention” to or otherwise visually highlight/elevate a specific work container (e.g., resource container unit) so that it gets attention from his or her team or team leader. The emphasize resource container unit insight interface component request may be detected in response to user interaction with a first resource container unit interface component of the resource container unit aggregation insight map interface. In some embodiments, the resource operation management server 210 may also be configured to receive additional data (e.g., textual information) to emphasize the specific concern that may be included in the visual emphasis element described in optional block 704.

As illustrated at optional block 704, in some embodiments, the resource operation management server 210 includes means, such as the memory 201, processor 202, input/output circuitry 203, communications circuitry 204, and/or resource operation insight circuitry 205, or a combination thereof, to generate a visual emphasis element configured to visually emphasize the first (e.g., selected) resource container unit interface component in comparison to at least one other resource container unit interface component of the plurality of resource container unit interface components.

As illustrated at optional block 706, in some embodiments, the resource operation management server 210 includes means, such as the memory 201, processor 202, input/output circuitry 203, communications circuitry 204, and/or resource operation insight circuitry 205, or a combination thereof, to output the visual emphasis element to the resource container unit aggregation insight map interface for rendering in association with the first (e.g., selected) resource container unit interface component.

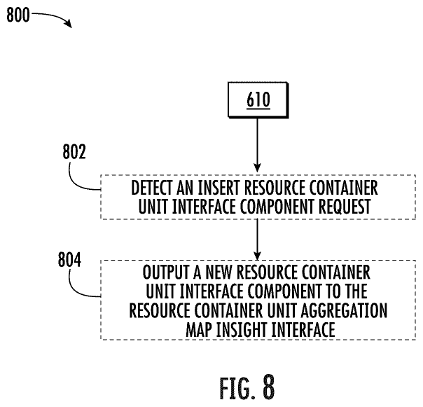

Turning now to FIG. 8, a flowchart broadly illustrates a series of optional operations or process blocks that are executed or performed to output a new resource container unit interface component to the resource container unit aggregation insight map interface in accordance with some example embodiments of the present disclosure. Subsequent to outputting the resource container unit aggregation insight interface for rendering to the resource operational interface in block 610, in some embodiments, the resource operation management server 210 includes means, such as the memory 201, processor 202, input/output circuitry 203, communications circuitry 204, and/or resource operation insight circuitry 205, or a combination thereof, to detect an insert resource container unit interface component request as illustrated at optional block 802. For example, a PgM may elect to create a new container of work (e.g., resource container unit) at any hierarchy level of the resource container unit aggregation insight map interface and the insert resource container unit interface component request may be generated in response to user interaction with the resource container unit aggregation insight map interface (e.g., an “Add Container” button).

As illustrated at optional block 804, in some embodiments, the resource operation management server 210 includes means, such as the memory 201, processor 202, input/output circuitry 203, communications circuitry 204, and/or resource operation insight circuitry 205, or a combination thereof, to output a new resource container unit interface component to the resource container unit aggregation insight map interface.

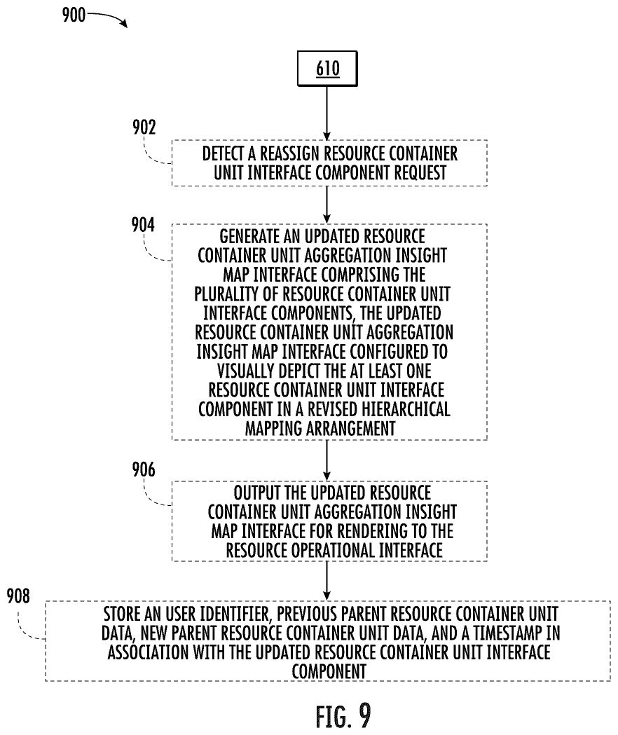

Turning now to FIG. 9, a flowchart broadly illustrates a series of optional operations or process blocks that are executed or performed to output a new resource container unit interface component to the resource container unit aggregation insight map interface in accordance with some example embodiments of the present disclosure. Subsequent to outputting the resource container unit aggregation insight interface for rendering to the resource operational interface in block 610, in some embodiments, the resource operation management server 210 includes means, such as the memory 201, processor 202, input/output circuitry 203, communications circuitry 204, and/or resource operation insight circuitry 205, or a combination thereof, to detect a reassign resource container unit interface component request as illustrated at optional block 902. For example, the reassign resource container unit interface component request may be generated in response to user interaction (e.g., drag and drop, etc.) with at least one resource container unit interface component of the resource container unit aggregation insight map interface. In a non-limiting illustration, a PgM may elect to re-map bodies of work (e.g., resource container units) so that the resource container unit aggregation insight map interface accurately reflects reality. In some embodiments, the reassign resource container unit interface component request may comprise a user identifier, previous parent resource container unit data, and new parent resource container unit data.

As illustrated at optional block 904, in some embodiments, the resource operation management server 210 includes means, such as the memory 201, processor 202, input/output circuitry 203, communications circuitry 204, and/or resource operation insight circuitry 205, or a combination thereof, to generate an updated resource container unit aggregation insight map interface comprising the plurality of resource container unit interface components, the updated resource container unit aggregation insight map interface configured to visually depict the at least one resource container unit interface component in a revised hierarchical mapping arrangement.

As illustrated at optional block 906, in some embodiments, the resource operation management server 210 includes means, such as the memory 201, processor 202, input/output circuitry 203, communications circuitry 204, and/or resource operation insight circuitry 205, or a combination thereof, to output the updated resource container unit aggregation insight map interface for rendering to the resource operational interface.

As illustrated at optional block 908, in some embodiments, the resource operation management server 210 includes means, such as the memory 201, processor 202, input/output circuitry 203, communications circuitry 204, and/or resource operation insight circuitry 205, or a combination thereof, to store the user identifier, the previous parent resource container unit data, the new parent resource container unit data, and a timestamp (e.g., timestamp associated with the reassign resource container unit interface component request) in association with the at least one resource container unit interface component. For example, the resource operation management server 210 may cause storage of the user identifier, the previous parent resource container unit data, the new parent resource container unit data, and the timestamp to a data repository, such as resource operation insight data repository 215. For example, such data may be stored in an “updates” file associated with the reassigned resource container unit interface component.

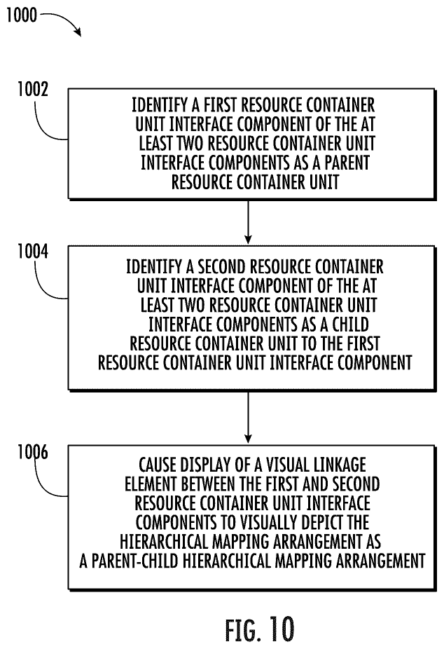

Turning now to FIG. 10, a flowchart broadly illustrates a series of operations or process blocks that are executed or performed to visually depict at least two of the resource container unit interface components in a hierarchical mapping arrangement in the resource container unit aggregation insight map interface in accordance with some example embodiments of the present disclosure. As with FIGS. 6, 7, 8, and 9, in some embodiments, the method 1000 is embodied by computer program code stored on a non-transitory computer-readable storage medium of a computer program product configured for execution to perform the process as depicted and described. In this regard, in some such embodiments, the resource operation management server 210 is specially configured by computer-coded instructions (e.g., computer program instructions) stored thereon, for example in the memory 201 and/or another component depicted and/or described herein and/or otherwise accessible to the resource operation management server 210, for performing the operations as depicted and described. Alternatively, or additionally, in some embodiments, the method 1000 is performed by one or more specially configured computing devices, such as the resource operation management server 210 alone or in communication with one or more other component(s), device(s), system(s), and/or the like. For purposes of simplifying the description, the method 1000 is described as performed by and from the perspective of the resource operation management server 210. In this regard, performance of the operations may invoke one or more of memory 201, processor 202, input/output circuitry 203, communications circuitry 204, and/or resource operation insight circuitry 205.

In the embodiment illustrated in FIG. 10, the flowchart illustrates method 1000 which begins at block 1002. At block 1002, the resource operation management server 210 may include means, such as the memory 201, processor 202, input/output circuitry 203, communications circuitry 204, and/or resource operation insight circuitry 205, or a combination thereof, to identify a first resource container unit interface component of the at least two resource container unit interface components as a parent resource container unit.

At block 1004, the resource operation management server 210 may include means, such as the memory 201, processor 202, input/output circuitry 203, communications circuitry 204, and/or resource operation insight circuitry 205, or a combination thereof, to identify a second resource container unit interface component of the at least two resource container unit interface components as a child resource container unit to the first resource container unit interface component.

In some embodiments, a parent resource container unit or a child resource container unit may be identified or manually set by an end user. For example, in some embodiments, end users may define such relationships in the resource operation management and collaboration system 200, such as via the resource operations interface 300 and/or the resource container unit aggregation insight map interface 305. In some embodiments, an express linkage indicates a parent-child relationship between two or more resource container units. For example, the source data that is accessed and/or integrated by the resource operation management server 210 may include the parent-child relationship. Additionally or alternatively, in some embodiments, the resource operation management server 210 may be configured to infer a linkage from the aggregate disparate data as described herein to determine such parent resource container unit (as discussed with respect to block 1002) and/or child resource container unit (as discussed with respect to block 1004). For example, the resource operation management server 210 may be configured to identify one or more patterns across the disparate data sets (e.g., Bob and Emily work on Project X and Project Y, respectively, and HR tool 108 provides data indicating that Bob and Emily are on the same team, such that the resource operation management server 210 may infer that such team works on Projects X and Y in order to determine a parent resource container unit (as discussed with respect to block 1002) and/or a child resource container unit (as discussed with respect to block 1004) based on such inferred linkage.

At block 1006, the resource operation management server 210 may include means, such as the memory 201, processor 202, input/output circuitry 203, communications circuitry 204, and/or resource operation insight circuitry 205, or a combination thereof, to cause display of a visual linkage element between the first and second resource container unit interface components to visually depict the hierarchical mapping arrangement as a parent-child hierarchical mapping arrangement. For example, in some embodiments, such hierarchical mapping arrangement may depict a link, connection, relationship, association, bond, and/or the like between two or more resource container unit interface components. That is, a resource container unit aggregation insight map interface may display a line, arrow, and/or the like that visually depicts such a parent-child hierarchical mapping arrangement. In the non-limiting example depicted in FIG. 3A, the resource container unit aggregation insight map interface in goals-first view may include a plurality of visual linkage elements showing the full or entire relationship (e.g., from upper-most parent to lowest child resource container unit) from the top-hierarchy enterprise goal of “Boost global guest retention by 15% through unique experiences” through the goal “Launch standards for high-quality content contributions” to the sub-goals thereto of “Launch content portal for external content contributors” and “Set cadence for publication of local guides”. For example, a user may elect to see how any work directly maps to overall company objective(s) to ensure clear alignment from bottom to top.

FIGS. 6-10 thus illustrate flowcharts and signal diagrams describing the operation of apparatuses, methods, systems, and computer program products according to example embodiments contemplated herein. It will be understood that each flowchart block, and combinations of flowchart blocks, may be implemented by various means, such as hardware, firmware, processor, circuitry, and/or other devices associated with execution of software including one or more computer program instructions. For example, one or more of the operations described above may be implemented by an apparatus executing computer program instructions. In this regard, the computer program instructions may be stored by a memory 201 of the resource operation management server 210 and executed by a processor 202 of the resource operation management server 210. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the functions specified in the flowchart blocks. The computer program instructions may also be loaded onto a computer or other programmable apparatus to cause a series of operations to be performed on the computer or other programmable apparatus to produce a computer-implemented process such that the instructions executed on the computer or other programmable apparatus provide operations for implementing the functions specified in the flowchart blocks.

The flowchart blocks support combinations of means for performing the specified functions and combinations of operations for performing the specified functions. It will be understood that one or more blocks of the flowcharts, and combinations of blocks in the flowcharts, can be implemented by special purpose hardware-based computer systems which perform the specified functions, or combinations of special purpose hardware with computer instructions.

Thus, particular embodiments of the subject matter have been described. While this specification contains many specific implementation details, these should not be construed as limitations on the scope of the present disclosure or of what may be claimed, but rather as description of features specific to particular embodiments of the present disclosure. Other embodiments are within the scope of the following claims. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products. Any operational step shown in broken lines in one or more flow diagrams illustrated herein are optional for purposes of the depicted embodiment.

In some cases, the actions recited in the claims can be performed in a different order and still achieve desirable results. In addition, the processes depicted in the accompanying figures do not necessarily require the particular order shown, or sequential order, to achieve desirable results, unless described otherwise. In certain implementations, multitasking and parallel processing may be advantageous.

### CONCLUSION

Many modifications and other embodiments of the present disclosure set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. An apparatus for outputting a resource container unit aggregation insight map interface to a resource operational interface, the apparatus comprising at least one processor, and at least one memory including program code, the at least one memory and the program code configured to, with the at least one processor, cause the apparatus to at least:
detect a resource container unit aggregation insight map interface request in response to user interaction with a resource operational interface;
access a plurality of candidate resource container units;
determine a selected resource container unit set from the plurality of candidate resource container units based on the resource container unit aggregation insight map interface request;
generate a resource container unit aggregation insight map interface comprising a plurality of resource container unit interface components corresponding to the selected resource container unit set, the resource container unit aggregation insight map interface configured to visually depict at least two of the resource container unit interface components in a hierarchical mapping arrangement; and
output the resource container unit aggregation insight map interface for rendering to the resource operational interface.

2. The apparatus of claim 1, wherein visually depicting at least two of the resource container unit interface components in a hierarchical mapping arrangement comprises:
identifying a first resource container unit interface component of the at least two resource container unit interface components as a parent resource container unit;
identifying a second resource container unit interface component of the at least two resource container unit interface components as a child resource container unit to the first resource container unit interface component; and
causing display of a visual linkage element between the first and second resource container unit interface components to visually depict the hierarchical mapping arrangement as a parent-child hierarchical mapping arrangement.

3. The apparatus of claim 1, wherein each of the resource container unit interface components comprises one or more of resource container unit title data, resource container unit progress data, resource container unit owner data, resource sub-container unit data, resource container unit key result data, resource container unit target completion data, resource container unit status data, resource container unit qualitative update data, resource container unit risk data, resource container unit financial data, or resource container unit team data.

4. The apparatus of claim 3, wherein a first resource container unit interface component comprises a visual emphasis element based on the resource container unit progress data, wherein the visual emphasis element is configured to visually compare current resource container unit progress data to target resource container unit data.

5. The apparatus of claim 3, wherein a first resource container unit interface component comprises a visual emphasis element based on the resource container unit risk data, wherein the visual emphasis element is configured to visually depict a current resource container unit risk.

6. The apparatus of claim 1, wherein the program code is further configured to, with the at least one processor, cause the apparatus to:
detect a detailed resource container unit insight interface component request in response to user interaction with a first resource container unit interface component of the resource container unit aggregation insight map interface;
generate a detailed resource container unit insight interface component comprising one or more additional resource container unit data; and
cause replacement of the first selected resource container unit with the detailed resource container unit insight interface component in the resource container unit aggregation insight map interface.

7. The apparatus of claim 1, wherein the program code is further configured to, with the at least one processor, cause the apparatus to:
detect an emphasize resource container unit interface component request in response to user interaction with a first resource container unit interface component of the resource container unit aggregation insight map interface;
generate a visual emphasis element configured to visually emphasize the first resource container unit interface component in comparison to at least one other resource container unit interface component of the plurality of resource container unit interface components; and
output the visual emphasis element to the resource container unit aggregation insight map interface for rendering in association with the first resource container unit interface component.

8. The apparatus of claim 1, wherein the program code is further configured to, with the at least one processor, cause the apparatus to:
detect an insert resource container unit interface component request in response to user interaction with the resource container unit aggregation insight map interface; and
output a new resource container unit interface component to the resource container unit aggregation insight map interface.

9. The apparatus of claim 1, wherein the program code is further configured to, with the at least one processor, cause the apparatus to:
detect a reassign resource container unit interface component request in response to user interaction with at least one resource container unit interface component of the resource container unit aggregation insight map interface;
generate an updated resource container unit aggregation insight map interface comprising the plurality of resource container unit interface components, the updated resource container unit aggregation insight map interface configured to visually depict the at least one resource container unit interface component in a revised hierarchical mapping arrangement; and
output the updated resource container unit aggregation insight map interface for rendering to the resource operational interface.

10. The apparatus of claim 9, wherein the reassign resource container unit interface component request comprises a user identifier, previous parent resource container unit data, and new parent resource container unit data, and wherein the program code is further configured to, with the at least one processor, cause the apparatus to:
store the user identifier, the previous parent resource container unit data, the new parent resource container unit data, and a timestamp in association with the at least one resource container unit interface component.

11. A method for outputting a resource container unit aggregation insight map interface to a resource operational interface, the method comprising:
detecting a resource container unit aggregation insight map interface request in response to user interaction with a resource operational interface;
accessing a plurality of candidate resource container units;
determining a selected resource container unit set from the plurality of candidate resource container units based on the resource container unit aggregation insight map interface request;
generating a resource container unit aggregation insight map interface comprising a plurality of resource container unit interface components corresponding to the selected resource container unit set, the resource container unit aggregation insight map interface configured to visually depict at least two of the resource container unit interface components in a hierarchical mapping arrangement; and
outputting the resource container unit aggregation insight map interface for rendering to the resource operational interface.

12. The method of claim 11, wherein visually depicting at least two of the resource container unit interface components in a hierarchical mapping arrangement comprises:
identifying a first resource container unit interface component of the at least two resource container unit interface components as a parent resource container unit;
identifying a second resource container unit interface component of the at least two resource container unit interface components as a child resource container unit to the first resource container unit interface component; and
causing display of a visual linkage element between the first and second resource container unit interface components to visually depict the hierarchical mapping arrangement as a parent-child hierarchical mapping arrangement.

13. The method of claim 11, wherein each of the resource container unit interface components comprises one or more of resource container unit title data, resource container unit progress data, resource container unit owner data, resource container unit target completion data, resource sub-container unit data, resource container unit key result data, resource container unit status data, resource container unit qualitative update data, resource container unit risk data, resource container unit financial data, or resource container unit team data.

14. The method of claim 11, the method further comprising:
detecting a detailed resource container unit insight interface component request in response to user interaction with a first resource container unit interface component of the resource container unit aggregation insight map interface;
generating a detailed resource container unit insight interface component comprising one or more additional resource container unit data; and
causing replacement of the first selected resource container unit with the detailed resource container unit insight interface component in the resource container unit aggregation insight map interface.

15. The method of claim 11, the method further comprising:
detecting an emphasize resource container unit interface component request in response to user interaction with a first resource container unit interface component of the resource container unit aggregation insight map interface;
generating a visual emphasis element configured to visually emphasize the first resource container unit interface component in comparison to at least one other resource container unit interface component of the plurality of resource container unit interface components; and
outputting the visual emphasis element to the resource container unit aggregation insight map interface for rendering in association with the first resource container unit interface component.

16. The method of claim 11, the method further comprising:
detecting an insert resource container unit interface component request in response to user interaction with the resource container unit aggregation insight map interface; and
outputting a new resource container unit interface component to the resource container unit aggregation insight map interface.

17. The method of claim 11, the method further comprising:
detecting a reassign resource container unit interface component request in response to user interaction with at least one resource container unit interface component of the resource container unit aggregation insight map interface;
generating an updated resource container unit aggregation insight map interface comprising the plurality of resource container unit interface components, the updated resource container unit aggregation insight map interface configured to visually depict the at least one resource container unit interface component in a revised hierarchical mapping arrangement; and
outputting the updated resource container unit aggregation insight map interface for rendering to the resource operational interface.

18. The method of claim 17, wherein the reassign resource container unit interface component request comprises a user identifier, previous parent resource container unit data, and new parent resource container unit data, and the method further comprises:
storing the user identifier, the previous parent resource container unit data, the new parent resource container unit data, and a timestamp in association with the at least one resource container unit interface component.

19. A computer program product for outputting a resource container unit aggregation insight map interface to a resource operational interface, the computer program product comprising at least one non-transitory computer-readable storage medium having computer-readable program code portions stored therein, the computer-readable program code portions comprising an executable portion configured to:
detect a resource container unit aggregation insight map interface request in response to user interaction with a resource operational interface;
access a plurality of candidate resource container units;
determine a selected resource container unit set from the plurality of candidate resource container units based on the resource container unit aggregation insight map interface request;
generate a resource container unit aggregation insight map interface comprising a plurality of resource container unit interface components corresponding to the selected resource container unit set, the resource container unit aggregation insight map interface configured to visually depict at least two of the resource container unit interface components in a hierarchical mapping arrangement; and
output the resource container unit aggregation insight map interface for rendering to the resource operational interface.

20. The computer program product of claim 19, wherein the computer-readable program code portions comprising an executable portion are further configured to:
output a visual emphasis element in association with at least one resource container unit interface component, the visual emphasis element configured to visually compare current resource container unit progress data to target resource container unit data of the at least one resource container unit interface component.
